(19) United States
(12) Patent Application Publication
(10) Pub. No.: US 2026/0180834 A1
(43) Pub. Date: Jun. 25, 2026

(54) DATA COMMUNICATION DEVICE AND DATA COMMUNICATION SYSTEM HAVING THE SAME

(71) Applicants: Sang-Hyun HAN, Anyang-si (KR); LEADING UI CO., LTD., Anyang-si (KR)

(72) Inventors: Sang-Hyun HAN, Anyang-si (KR); Seung-Hee HAN, Anyang-si (KR)

(73) Assignees: Sang-Hyun HAN, Anyang-si (KR); LEADING UI CO., LTD., Anyang-si (KR)

(21) Appl. No.: 19/253,949

(22) Filed: Jun. 29, 2025

(30) Foreign Application Priority Data
Dec. 23, 2024 (KR) 10-2024-0194266
Feb. 24, 2025 (KR) 10-2025-0023511
Jun. 18, 2025 (KR) 10-2025-0079966

(51) Int. Cl. H04L 25/02

(52) U.S. Cl. CPC H04L 25/0282; H04L 25/0294

(57) ABSTRACT

A data communication device may include a data transmission line, a first communication module and a second communication module. The first communication module converts a TX signal of a voltage level into a TX signal of a current level, and outputs the converted TX signal to the data transmission line, in order to communicate solely using current, free from interference between the capacitive load present on the data transmission line and the data transmission line. The second communication module converts an RX signal of a current level into an RX signal of a voltage level, in order to communicate solely using current, free from interference between the capacitive load present on the data transmission line and the data transmission line. The first and second communication modules include a mode switching switch allowing switching between a data transmission mode and a data receiving mode.

### CROSS-REFERENCE TO RELATED APPLICATIONS

This application claims priority under 35 U.S.C. § 119 to Korean Patent Application No. 10-2024-0194266, filed on Dec. 23, 2024, Korean Patent Application No. 10-2025-0023511, filed on Feb. 24, 2025 and Korean Patent Application No. 10-2025-0079966, filed on Jun. 18, 2025 in the Korean Intellectual Property Office (KIPO), the contents of which are herein incorporated by reference in their entirety.

### BACKGROUND OF THE INVENTION

### Technical Field

Exemplary embodiments of the present invention relate to a data communication device and a data communication system having the data communication device. More particularly, exemplary embodiments of the present invention relate to a data communication device that performs communication with only a current signal by minimizing the amplitude of a voltage signal accompanying signal transmission and a data communication system having the data communication device.

### Discussion of the Related Art

The most problematic thing in high-speed communication by wire is the parasitic capacitance present between the transmission line and the ground signal and the matching capacitance value present between the transmission lines. The inductance component and the resistance component of the transmission line also affect the high-speed communication of the wire, but due to the development of high-speed transmission line manufacturing technology, the inductance component and the resistance component are relatively negligible. Since the signal is transmitted using the amount of change in voltage appearing on the high-speed transmission line, the capacitance value of the transmission line increases the time constant and the capacitive load, making it difficult to transmit high-speed data or communicate data between long lines (long-distance data communication).

In general, when a signal voltage having a pulse period or phase information is applied, a line capacitance is an element that interferes with communication by generating effects such as distortion and attenuation of a signal, a phase delay, and the like.

Wired high-speed serial communication techniques such as MIPI, LVDS, USB2.0, USB3.0, SATA, etc., which have been known until recently, have increased the speed through high-speed serial signal transmission by reducing an amplitude of the signal voltage to reduce the effect of the capacitive load.

A current value ‘i’ required for signal transmission may be defined by i=C*(dv/dt). That is, as a frequency component dv/dt (that is, an amount of voltage fluctuation over time) increases, the amount of current ‘i’ required for signal transmission increases even though a value of C, which is the same capacitive load, is constant. In addition, impedance on the signal line also acts as a resistance, increasing the time constant, thereby interfering with high-speed signal transmission.

Meanwhile, due to the advent of big data applications such as artificial intelligence (AI), virtual reality, and media streaming, the amount of data computed and transmitted is increasing significantly. The energy cost of DRAM access in computing systems is increasing as system performance is advanced.

### SUMMARY

Exemplary embodiments of the present invention provide a data communication device that performs communication with only a current signal by minimizing the amplitude of a voltage signal accompanying signal transmission in an actual implementation by applying a current signal-based communication technique.

Exemplary embodiments of the present invention also provide a data communication device having the above-described data communication device.

According to one aspect of the present invention, a data communication device may include a data transmission line, a first communication module and a second communication module. The first communication module is connected to one side of the data transmission line and is configured to convert a TX signal of a voltage level provided by an external device into a TX signal of a current level, and output the converted TX signal to one side of the data transmission line, in order to communicate solely using current, free from interference between the capacitive load present on the data transmission line and the data transmission line. The second communication module is connected to the other side of the data transmission line and is configured to convert an RX signal of a current level, provided via the data transmission line, into an RX signal of a voltage level, in order to communicate solely using current, free from interference between the capacitive load present on the data transmission line and the data transmission line. The first communication module and the second communication module each include a mode switching switch that allows switching between a data transmission mode and a data receiving mode, or between a data receiving mode and a data transmission mode, controlled by a communication direction control signal, enabling bidirectional communication.

In an exemplary embodiment of the present invention, the data transmission line may include at least one of a Through Silicon Via (TSV), a Through Glass Via (TGV), a Silicon Interposer, a Glass Interposer, and a PCB pattern.

In an exemplary embodiment of the present invention, each of the first communication module and the second communication module may include a current conveyor including an EN-port for receiving an EN signal, a Y-port for receiving a common-mode voltage, an X-port, and a ZP-port connected to a mode switching switch. Here, the current conveyor converts a voltage level TX signal into a current level TX signal and simultaneously mirrors the converted current level TX signal for output.

In an exemplary embodiment of the present invention, the mode switching switch may include a first terminal connected to the ZP-port of the current conveyor, a second terminal connected to the X-port of the current conveyor, and a third terminal connected to the I/O pad of the data transmission line. Here, the ZP-port of the current conveyor and the I/O pad are connected to each other, when the first terminal and the third terminal are connected to each other, and the X-port of the current conveyor and the I/O pad are connected to each other when the second terminal and the third terminal are connected to each other.

In an exemplary embodiment of the present invention, each of the first communication module and the second communication module may further include a TX buffer receiving the voltage level TX signal, a TX resistor connected to an output terminal of the TX buffer, and a TX switch connected between the TX resistor and the X-port of the current conveyor. Here, the current conveyor is connected to the mode switching switch through the ZP-port.

In an exemplary embodiment of the present invention, each of the first communication module and the second communication module may further include a second switch connected to the ZP-port of the current conveyor, and at least one of an RC parallel circuit and a resistive element having one end connected to the second switch and the other end connected to a common-mode voltage.

In an exemplary embodiment of the present invention, when the at least one of the first communication module and the second communication module operates in a data receiving mode, the received current transmitted through the data transmission line is applied to the X-port of the current conveyor of the communication module operating in a data receiving mode. The common-mode voltage is applied to the Y-port of the corresponding current conveyor. The current mirrored from the received current based on the common-mode voltage is output through the ZP-port of the corresponding current conveyor. The mirrored current output through the ZP-port of the current conveyor is converted into a voltage by the at least one of the RC parallel circuit and the resistive element.

In an exemplary embodiment of the present invention, each of the first communication module and the second communication module further includes an RX buffer connected to the RC parallel circuit or the resistive element.

In an exemplary embodiment of the present invention, the RX buffer includes one of a Schmitt-trigger circuit, a logic buffer and a comparator circuit.

In an exemplary embodiment of the present invention, each of the first communication module and the second communication module includes a transmission mode unit and a reception mode unit. The transmission mode unit converts the voltage level TX signal into a current level signal and outputting the converted current level signal through the I/O pad to the data transmission line. The reception mode unit converts the current level signal input from the data transmission line connected through the I/O pad into a voltage level RX signal.

In an exemplary embodiment of the present invention, the transmission mode unit includes a first buffer and a voltage-to-current converter. The first buffer includes a front-end inverter enabled by a TX_EN signal that inverts the TX signal, and a rear-end inverter connected to a rear end of the front-end inverter and enabled by the TX_EN signal to invert the signal inverted by the front-end inverter. The voltage-to-current converter is connected to the output terminal of the first buffer and the I/O pad to include a pull-up current source, a pull-down current source, a pull-up switch and a pull-down switch.

In an exemplary embodiment of the present invention, the reception mode unit includes a buffer that is enabled by a TX_EN signal and buffers the TX signal.

In an exemplary embodiment of the present invention, the reception mode unit further includes a voltage-to-current converter connected to the rear end of the buffer and providing a pull-up current source and a pull-down current source.

In an exemplary embodiment of the present invention, the reception mode unit includes a resistor.

In an exemplary embodiment of the present invention, the reception mode unit includes an RX current conveyor, at least one of an RC parallel circuit and resistive element, and an RX buffer. The RX current conveyor is connected to the I/O pad. The at least one of an RC parallel circuit and resistive element receive and charges the received current output through the ZP-port of the RX current conveyor to form a received voltage. The RX buffer outputs the received voltage formed by the at least one of the RC parallel circuit ant the resistive element through the RX terminal to an external device.

In an exemplary embodiment of the present invention, each of the first communication module and the second communication module may include a first TX buffer, a second TX buffer, a first TX resistor, a second TX resistor, and a TX switch. The first TX buffer receives a first TX signal of a voltage level. The second TX buffer receives a second TX signal of a voltage level. The first TX resistor is connected to an output terminal of the first TX buffer. The second TX resistor is connected to an output terminal of the second TX buffer. The TX switch has one end connected to the first TX resistor and the second TX resistor, and the other end connected to the X-port of the current conveyor.

In an exemplary embodiment of the present invention, each of the first communication module and the second communication module includes a PAM4 signal generator. The PAM4 signal generator includes a first TX buffer, a second TX buffer, a first TX resistor, and a second TX resistor. The first TX buffer receives the first TX signal of the voltage level. The second TX buffer receives a second TX signal of the voltage level. The first TX resistor has one end connected to the output terminal of the first TX buffer and the other end connected to the data transmission line. The second TX resistor has one end connected to the output terminal of the second TX buffer and the other end connected to the data transmission line.

In an exemplary embodiment of the present invention, each of the first communication module and the second communication module includes an RX switch, at least one of an RC parallel circuit and a resistive element, and a PAM4 signal restorer. The RX switch is connected to the ZP-port of the current conveyor and the mode switching switch. The at least one of the RC parallel circuit and the resistive element connected to the RX switch. The PAM4 signal restorer restores an RX signal passing through the RC parallel circuit or the resistive element.

In an exemplary embodiment of the present invention, each of the first communication module and the second communication module may be switchable between a data transmission mode and a data receiving mode. The TX switch is turned-on and the RX switch is turned-off in a data transmission mode, and the TX switch is turned-off and the RX switch is turned-on in a data receiving mode.

In an exemplary embodiment of the present invention, each of the first TX buffer and the second TX buffer may output the transmission signal to the data transmission line in a data transmission mode, and the RX buffer may restore the received signal in a data receiving mode.

In an exemplary embodiment of the present invention, the PAM4 signal restorer may include a first comparator, a second comparator, a third comparator, and a logic encoder. The first comparator compares the RX signal with a first reference voltage to output a first result. The second comparator compares the RX signal with a second reference voltage to output a second result. The third comparator compares the RX signal with a third reference voltage to output a third result. The logic encoder expresses the first to third results as a RXA[1:0] of 2-bit.

In an exemplary embodiment of the present invention, the first communication module may convert a first transmission signal provided from an external device into a first transmission current and outputs the converted first transmission current to the data transmission line, and the second communication module may output a first reception current, which is in the opposite phase to the first transmission current, through the data transmission line, thereby minimizing a voltage change on the data transmission line.

In an exemplary embodiment of the present invention, the second communication module may mirror the first reception current and outputs the transmission signal restored to the first received voltage.

In an exemplary embodiment of the present invention, the second communication module may convert a second transmission signal provided from an external device into a second transmission current and outputs the converted second transmission current to the data transmission line, and the first communication module may output a second reception current, which is in the opposite phase to the second transmission current, through the data transmission line, thereby minimizing a voltage change on the data transmission line.

In an exemplary embodiment of the present invention, the first communication module may mirror the second reception current and outputs the transmission signal restored to the second received voltage.

In an exemplary embodiment of the present invention, each of the first communication module and the second communication module may include a receiving unit for receiving an RX signal in the physical layer through the data transmission line, and the receiving unit may include a voltage generating part for converting a current of the RX signal provided through the data transmission line into a voltage.

In an exemplary embodiment of the present invention, the voltage generating part may further include a variable resistor having a first end connected to the data transmission line and a second end connected to the current conveyor.

According to another aspect of the present invention, a data communication system may include a data transmission line section, a first communication module section, and a second communication module section. The data transmission line section includes a plurality of data transmission lines arranged in parallel. The first communication module section includes a plurality of first communication modules arranged in parallel and is connected to one end of the data transmission line section. The second communication module section includes a plurality of second communication modules arranged in parallel and is connected to the other end of the data transmission line section. The first communication module is configured to convert a TX signal of a voltage level, provided by an external device, into a TX signal of a current level and output the converted TX signal to one side of the data transmission line, in order to communicate solely using current, free from interference between the capacitive load present on the data transmission line and the data transmission line. The second communication module is configured to convert an RX signal of a current level, provided via the data transmission line, into an RX signal of a voltage level, in order to communicate solely using current, free from interference between the capacitive load present on the data transmission line and the data transmission line. The first communication module and the second communication module each include a mode switching switch that allows switching between a data transmission mode and a data receiving mode, or between a data receiving mode and a data transmission mode, controlled by a communication direction control signal, enabling bidirectional communication.

According to the data communication device and the data communication system having the data communication device, by converting a current signal-based communication technique, that is, a voltage level TX signal into a current level TX signal, output the current level TX signal to one side of the data transmission line, and converting the current level RX signal provided through the data transmission line into a voltage level RX signal, communication may be performed only with a current signal by minimizing the amplitude of the voltage signal transmission in the actual implementation to less than 0V or tens of mV.

### BRIEF DESCRIPTION OF THE DRAWINGS

The above and other features and aspects of the present invention will become more apparent by describing in detailed exemplary embodiments thereof with reference to the accompanying drawings, in which:

FIG. 1 is a cross-sectional view illustrating a 2.5D system-in-package (SiP) processor module including high bandwidth memory (HBM);

FIG. 2 is a diagram for explaining a switching activity of a capacitive load;

FIG. 3 is a circuit diagram for explaining a connection structure between a first communication module and a second communication module that transmits/receives a data signal at high speed;

FIG. 4 is a configuration diagram for explaining a data communication device according to an exemplary embodiment of the present invention;

FIG. 5 is a circuit diagram modeling a case in which one data transmission line shown in FIG. 4 is configured;

FIG. 6 is a circuit diagram modeling a case in which two data transmission lines shown in FIG. 4 are configured;

FIG. 7 is a diagram for explaining a configuration of a general I/O pad corresponding to the I/O pad shown in FIG. 4;

FIG. 8 is a diagram for explaining an ESD preventing FET structure corresponding to the I/O pad shown in FIG. 4;

FIG. 9 is a diagram illustrating the symbol of the current conveyor;

FIG. 10 is a circuit diagram for explaining a current conveyor according to an example;

FIG. 11 is a graph for explaining a rail-to-rail input;

FIG. 12 is a graph for explaining current characteristics of p-channel MOSFET MP10 and n-channel MOSFET MN10 included in the first driver shown in FIG. 10;

FIG. 13 is a circuit diagram for explaining a current conveyor according to another example;

FIG. 14 is a diagram for explaining an example of a first communication module shown in FIG. 4;

FIG. 15 is a circuit diagram for explaining that the first communication module shown in FIG. 14 operates in a data transmission mode;

FIG. 16 is a circuit diagram for explaining that the first communication module shown in FIG. 14 operates in a data receiving mode;

FIG. 17 is a diagram for explaining another example of the first communication module shown in FIG. 4;

FIG. 18 is a circuit diagram for explaining another application example in which the voltage-to-current converters of FIG. 17 are replaced with a buffer and a resistor;

FIG. 19 is a diagram for explaining an example of implementing four data transmission lines shown in FIG. 4;

FIG. 20 is a circuit diagram for explaining an example of the data communication device shown in FIG. 4;

FIG. 21 is a circuit diagram for explaining an example of a TX buffer shown in FIG. 20;

FIG. 22 is a circuit diagram for explaining another example of the TX buffer shown in FIG. 20;

FIG. 23 is a circuit diagram for explaining another example of the TX buffer shown in

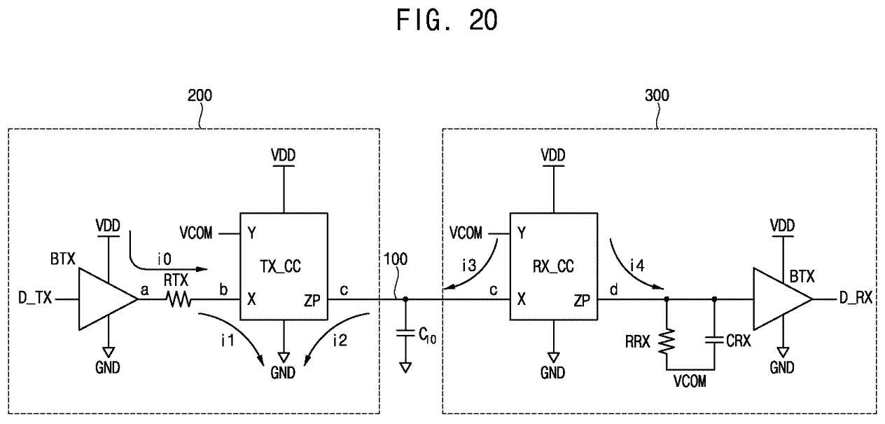

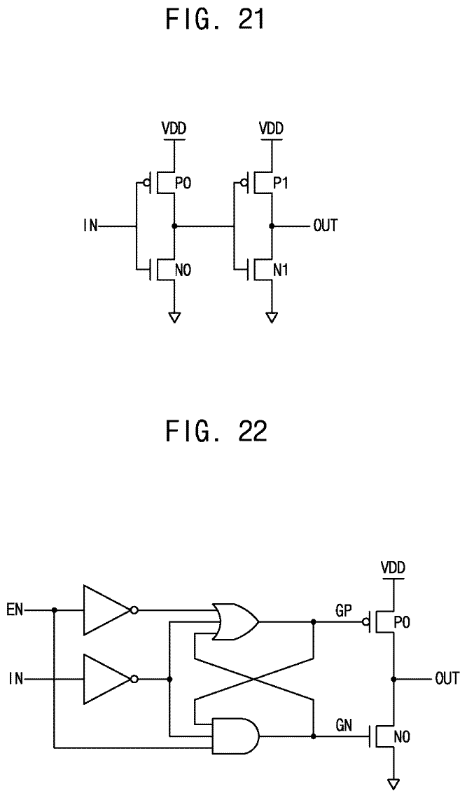

FIG. 20;

FIG. 24 is a block diagram for explaining a data communication system according to an exemplary embodiment of the present invention;

FIG. 25 is a circuit diagram for explaining the first communication module shown in FIG. 24;

FIG. 26 is a circuit diagram illustrating another example of the first communication module shown in FIG. 24;

FIG. 27 is a circuit diagram illustrating another example of the first communication module shown in FIG. 24;

FIG. 28 is a block diagram for explaining the first differential decoder shown in FIG. 24;

FIG. 29 is a block diagram for explaining a data communication system according to another exemplary embodiment of the present invention;

FIG. 30 is a circuit diagram for explaining a PAM4 signal generator and a PAM4 signal restorer provided in the first communication module shown in FIG. 24;

FIG. 31 is a block diagram for explaining a PAM4 signal restorer shown in FIG. 30;

FIG. 32 is a circuit diagram of another example for explaining a PAM4 signal generator and a PAM4 signal restorer provided in the first communication module shown in FIG. 24;

FIG. 33 is a waveform diagram showing a simulation result of each of Examples and Comparative Examples transmitting a data pattern to one data transmission line;

FIG. 34 is a configuration diagram for explaining a data communication system according to another exemplary embodiment of the present invention;

FIG. 35 is a configuration diagram for explaining a data communication system according to another exemplary embodiment of the present invention;

FIG. 36 is a circuit diagram for explaining the first communication module shown in FIG. 35;

FIG. 37 is a block diagram for explaining a first differential signal decoder shown in FIG. 35;

FIG. 38 is a diagram for explaining another example of a decoding unit added to the second communication module unit shown in FIG. 36;

FIG. 39 is a diagram for explaining another example of a decoding unit added to the second communication module unit shown in FIG. 36.

FIG. 40 is a circuit diagram illustrating an example of a receiving unit provided in the data communication device of the present invention; and

FIG. 41A, FIG. 41B, and FIG. 41C are graphs showing the signal amplitude according to the output impedance of the X-port of the receiving unit shown in FIG. 40.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as shown in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions shown in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

The terms described in this present specification are defined as follows.

The term “Processor Unit” refers to an IC in charge of logical operations such as AI Processor, GPU, CPU, SoC, etc.

The term “processor module” refers to a board or assembly including an HBM and a processor unit.

The term “DDR RAM” includes DDR4, DDR5, DDR6, GDDR5, GDDR6, etc.

The term “TSV link” refers to a signal transmission line (data transmission line) connected by TSV between DRAM dies and interface dies within HBM.

The term “T-Link” refers to a silicon interposer between the processor unit and the HBM, or a signal transmission line (i.e., a data transmission line) connected by a PCB.

The term “physical layer (PHY)” refers to a layer that transmits and receives data in each bit unit as an electrical signal, and refers to a layer that transmits and receives an electrical signal to an actual data transmission line. The present invention relates to the PHY.

The “data communication device” is configured to communicate a high-speed signal with only current, free from the capacitive load of a data transmission line, and includes a first communication module disposed on one side, a second communication module disposed on the other side, and a single data transmission line connecting the first communication module and the second communication module. The first communication module and the second communication module may operate selectively in a data transmission mode and a data receiving mode according to a control signal, respectively. The “data communication device” may support bidirectional communication.

The “data communication system” includes two or more data communication devices and transmits data by using two or more data transmission lines. The “data communication system” may include various combinations of communication modules such as 256 data transmission lines, 512 data transmission lines, 1024 data transmission lines, and 2048 data transmission lines.

The term “data transmission line” or “communication line” means a means of signal transmission using an electrical conductor consisting of a silicon through-silicon via (TSV), glass through-silicon via (TGV), silicon interposer, glass interposer, printed circuit board, etc.

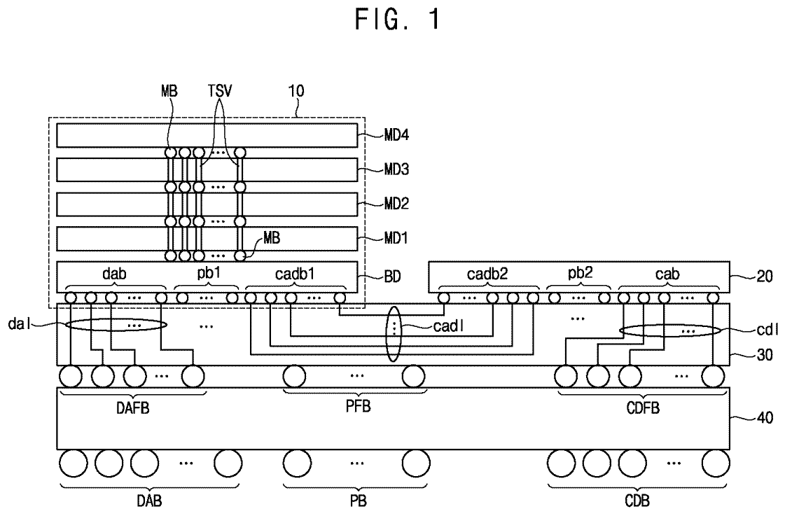

The main data link between the DRAM and the processor unit, such as GPU, CPU, SoC, etc., is a through-silicon via (TSV) link for HBM and a transmission line (T-line) link for HBM and the processor, which is shown in FIG. 1.

FIG. 1 is a cross-sectional view illustrating a 2.5D system-in-package (SiP) processor module including high bandwidth memory (HBM).

Referring to FIG. 1, a processor module may include an HBM device 10, a controller 20, an interposer 30, and a printed circuit board (PCB) 40. For example the system device 100 may be a semiconductor package including a plurality of semiconductor dies mounted on the PCB 40, which may be encapsulated by an encapsulant, and the PCB 40 may be a package substrate.

The HBM device 10 may include memory dies MD1 to MD4 and a base die BD (which may be described as and may be a buffer die, or a logic die). The memory dies MD1 to MD4 and the base die BD may be stacked in a vertical direction, and the stacked memory dies MD1 to MD4 are located above the base die BD. Each die, also described as a chip or semiconductor chip, may include an integrated circuit formed from a wafer. First bumps MB are formed between the stacked memory dies MD1 to MD4 and the base die BD, and through silicon vias (TSV) passing through the memory dies MD1 to MD4 may be formed between the first bumps MB. First direct access (DA) bumps dab, first power bumps pb1, and first command/address bumps and data bumps cadb1 may be arranged on a lower surface of the base die BD. The various bumps described herein may be referred to herein as interconnection terminals, or connection terminals, that transfer signals and/or voltage to, from, or between dies or substrates. The TSV may be referred to as a TSV-link, and the first main bumps cadb1 may be referred to as a T-link.

Second command/address bumps and data bumps cadb2, second power bumps pb2, and first control signal and data bumps cdb may be arranged on a lower surface of the controller 20. The controller 20 may be a graphic processing unit (GPU) die, a central processing unit (CPU) die, or a system-on-chip (SoC) die, etc.

The first bumps MB, the first DA bumps dab, the first and second power bumps pb1 and pb2, the first and second command/address bumps and data bumps cadb1 and cadb2, and the first control signal and data bumps cdb may be micro bumps.

Second DA bumps DAFB, third power bumps PBFB, and second control signal and data bumps CDFB may be arranged on a lower surface of the interposer 30. The interposer 30 may include DA lines dal connecting the first DA bumps dab and the second DA bumps DAFB, command/address lines and data lines cad1 connecting the first command/address bumps and data bumps cadb1 and the second command/address bumps and data bumps cadb2, and control signal and data lines cd1 connecting the first control signal and data bumps cdb and the second control signal and data bumps CDFB. Although not shown, power lines connecting the first power bumps pb1 and the third power bumps PBFB and connecting the second power bumps pb2 and the third power bumps PBFB may be further included in the interposer 30. The second DA bumps DAFB, the third power bumps PBFB, and the second control signal and data bumps CDFB may be flip die bumps.

DA balls DAB, power balls PB, and control signal and data balls CDB may be arranged on a lower surface of the PCB 40. The second DA bumps DAFB and the DA balls DAB may be connected, the third power bumps PBFB and the power balls PB may be connected, and the second control and data bumps CDFB and the control signal and data balls CDB may be connected, through the PCB 40. The various bumps or balls described herein connect to circuitry within one or more dies that the bumps are connected to. For example, power bumps or balls connect to circuit elements within a die that receive power signals (e.g., a constant voltage signal), and control signal and data bumps or balls connect to circuit elements within a die that receive control signals and/or data.

The processor module illustrated in FIG. 1 is coupled by a 2.5D System in Package (SiP) technology in which plural semiconductor chips are coupled in one package. Compared with 3D, 2.5D has a horizontal interlayer connection, in which several chips are disposed on the same substrate and communicate with each other through a high-speed connection. Using 2.5D SiP technology, the processor and the HBM memory are placed physically close to each other and connected through an interposer, thereby increasing the data transmission speed. This structure enables high-performance processing devices such as CPUs, GPUs and AI processors to exchange data with memories quickly.

With the advent of the big data era, memory designers are increasing the data transmission speed every year. For example, GDDR6 and HBM3 have reached up to 24 and 6.4 Gb/s/ch, respectively. Both TSV-link and T-link have large parasitic capacitance (CIO). According to the JEDEC standard, the parasitic capacitance (CIO) of the TSV-link, which is the communication link of HBM2, and the T-link, which is the communication link of DDR5, are about 2.4 pF and about 0.9 pF, respectively.

Under these heavy loads, high-speed data transmission inevitably leads to thermal issues, which leads to high power consumption and reduced overall computing performance.

Meanwhile, in communication links connected to digital circuits, dynamic power consumption occurs due to frequent switching activities of capacitive loads.

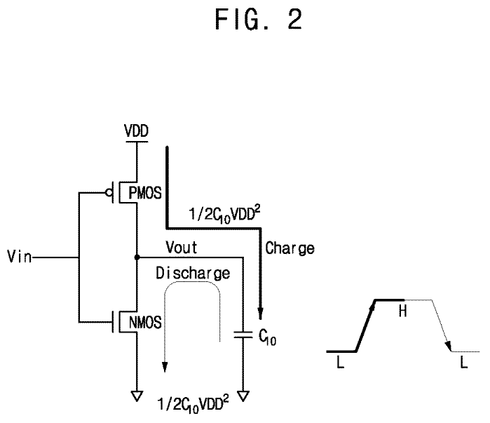

Referring to FIG. 2, when the output of the Vout signal line is switched from low to high, the output load (CIO) is charged from 0V (GND) level to the first power voltage VDD by the power supply source. At this stage, half (½ CIO*VDD²) of the energy consumed to make Vout to the VDD signal level from the supply source (i.e., the VDD power supply voltage source) is converted into heat by the on-resistance of the PMOS element, and the remaining half is stored in the output load (CIO).

When the output is converted from high to low, the charge stored in the output load (CIO) is discharged to the ground (GND), and the remaining half of the energy at this stage is converted into heat through the on-resistance of the NMOS element. Therefore, at the end of a complete low-to-high and high-to-low transition period, energy per cycle is consumed by CIO*VDD² (J, Joule). This may be expressed as follows.

In other words, the total energy required to drive a signal with a low-to-high transition or a high-to-low transition is as shown in the following Equation (1).

Eₜₒₜₐₗ(J)=C_{IO}×VDD² [Equation 1]

The total energy is converted into heat. Also, as the data transmission speed increases, the number of times charging and discharging are performed per second increases, so high-speed data transmission typically consumes as much power and generates as much heat as the speed.

As shown in the above Equation (1), in order to reduce power consumption and calorific value, it is necessary to reduce the voltage applied to the capacitance component or to reduce the capacitance value itself.

However, according to the above Equation (1), since the energy value is proportional to the square of the first power voltage VDD, it may be seen that reducing the voltage is more effective in reducing power consumption than reducing capacitance.

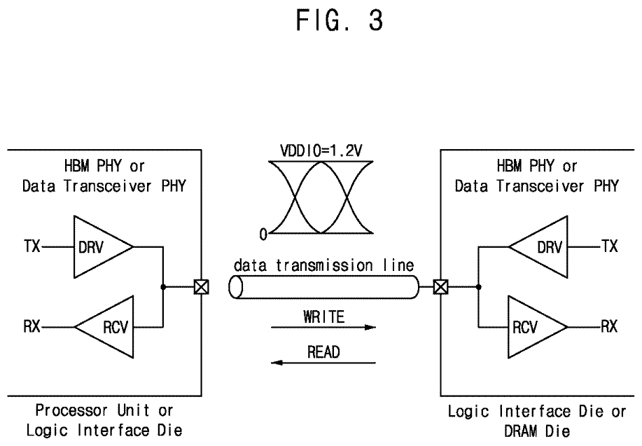

FIG. 3 is a circuit diagram for explaining a connection structure between a first communication module and a second communication module that transmits/receives a data signal at high speed. In particular, it illustrates the circuit configuration of a physical layer (PHY) responsible for communication between a first communication module, which is an HBM device that transmits data at high speed, and a second communication module, which is a processor unit.

Referring to FIG. 3, the data transmission line is disposed between the first communication module and the second communication module to transmit the TX signal transmitted from the first communication module to the second communication module or the TX signal transmitted from the second communication module to the first communication module.

The first communication module and the second communication module transmit/receive data in the HBM physical layer or the data transmission/reception physical layer. That is, each of the first communication module and the second communication module transmits data of an upper layer to a physical layer, and the physical layer converts the received data of an upper layer into a signal and transmits the signal. On the contrary, when the signal received from the physical layer is transmitted to the communication module, the communication module restores the received signal to data usable at an upper layer again. Each of the first communication module and the second communication module converts data received from an upper layer into a format capable of being transmitted from a physical layer (i.e., a bit stream), and converts a received bit stream into data that may be understood by an upper layer again.

When the first communication module includes a processor unit, the second communication module may include a logic interface die, and when the first communication module includes a logic interface die, the second communication module may include a processor unit.

Each of the first communication module and the second communication module includes a transmitting unit DRV for transmitting a TX signal in the physical layer to the data transmission line and a receiving unit RCV for receiving an RX signal in the physical layer through the data transmission line.

Since the signal transmission waveform of this circuit has an amplitude of about 0V and VDDIO (e.g., about 0.8V to about 1.2V), energy consumption is high for charging and discharging the load capacitance of the data transmission line.

The present invention proposes a method for enabling high-speed data communication while reducing the range of a charging voltage and a discharging voltage of a parasitic capacitance (CIO) required for communication (data transmission) to about 0V or several mV or less.

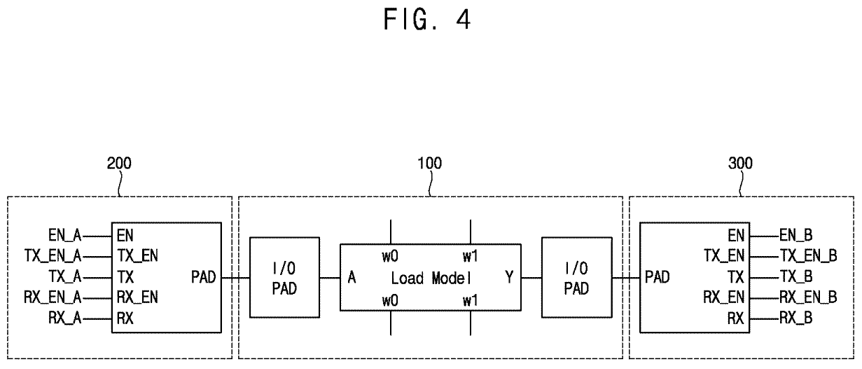

FIG. 4 is a configuration diagram for explaining a data communication device according to an exemplary embodiment of the present invention.

Referring to FIG. 4, a data communication device according to an embodiment of the present invention includes a data transmission line 100, a first communication module 200 connected to one end of the data transmission line 100, and a second communication module 300 connected to the other end of the data transmission line 100.

The first communication module 200 includes a first EN port to which the first enable signal EN_A is input, a first TX_EN port to which the first transmission enable signal TX_EN_A is input, a first TX port to which the first TX signal is input, a first RX_EN port to which the first reception enable signal RX_EN_A is input, a first RX port to which the first RX signal is input, and a first PAD port connected to the first I/O pad of the data transmission line 100.

The second communication module 300 includes a second EN port to which a second enable signal EN_B is input, a second TX_EN port to which a second transmission enable signal TX_EN_B is input, a second TX port to which a second reception enable signal RX_EN_B is input, a second RX port to which a second RX signal is input, and a second PAD port connected to a second I/O pad of the data transmission line 100.

The data communication device according to the present invention may refer to an arbitrary apparatus including the first communication module 200 and the second communication module 300.

In some embodiments, the data communication device according to the present invention includes a computing system that may be a portable computing system including a laptop computer, a tablet computer, a smartphone, a wearable device, a portable media player (PMP), etc., or a stationary computing system such as a desktop computer, a server, an electronic appliance, etc.

In some embodiments, the data communication device according to the present invention may include a component of the above-described computing systems, a vehicle control system, an industrial control system, etc., and may include a module including a board, on which the first communication module 200 and the second communication module 300 are mounted.

In some embodiments, the first communication module 200 and the second communication module 300 may include semiconductor chips manufactured through semiconductor processes. The first communication module 200 and the second communication module 300 may be included in one semiconductor package in some embodiments, or may be mounted on a printed circuit board as independent packages in some other embodiments. The first communication module 200 may include, as non-limiting examples, an application processor (AP), an application specific integrated circuit (ASIC), an application specific instruction set processor (ASIP), a field programmable gate array (FPGA), etc. The second communication module 300 may include, as non-limiting examples, a non-volatile memory such as electrically erasable programmable read-only memory (EEPROM), flash memory, phase change RAM (PRAM), resistance RAM (RRAM), nano floating gate memory (NFGM), polymer RAM (PoRAM), magnetic RAM (MRAM), ferroelectric RAM (FRAM), etc, or a volatile memory such as dynamic RAM (DRAM), static RAM (SRAM), mobile DRAM, double data rate synchronous DRAM (DDR SDRAM), low power DDR (LPDDR) SDRAM, graphic DDR (GDDR) SDRAM, rambus DRAM (RDRAM), etc.

In addition, when the first communication module 200 includes a processor unit that performs calculations and processes data, the second communication module 300 includes a logic interface die that provides a physical/logical interface for connection with other parts of the system to manage signal transmission and interfaces between various hardware devices, and when the first communication module 200 includes a logic interface die, the second communication module 300 may include a processor unit.

In addition, each of the first communication module 200 and the second communication module 300 may be a processor unit that performs calculation and processes data.

In addition, each of the first communication module 200 and the second communication module 300 may be a memory device that stores data.

The first communication module 200 and the second communication module 300 may communicate with each other through the data transmission line 100. The first communication module 200 may provide, for example, commands and addresses such as a write command and a read command to the second communication module 300 through the data transmission line 100. Moreover, the first communication module 200 may provide data to the second communication module 300 together with the write command, and may receive data from the second communication module 300 in response to the read command.

In the present specification, a signal provided by the first communication module 200 to the second communication module 300 through the data transmission line 100 and a signal received from the second communication module 300 may be referred to as a TX signal. Hereinafter, embodiments of the present disclosure will be mainly described with reference to an operation in which the first communication module 200 writes a TX signal to the second communication module 300.

As a non-limiting example, the data transmission line 100 may refer to a bus protocol for communication, such as DDR2, DDR4, GDDR, and the like, and may define at least one channel. In some embodiments, the data transmission line 100 may define independent channels for a command, an address and data, and may define a channel shared by two or more of the command, the address, and the data. The channel may include at least one signal line, and the command, the address and the data may move as an electrical signal through at least one signal line.

As the amount of data required to be processed in the data communication device according to the present invention increases, the amount of data processed in the first communication module 200 may increase. Accordingly, the first communication module 200 may communicate more frequently with the second communication module 300 through the data transmission line 100 for writing and/or reading data, and power consumed by the second communication module 300 and the data transmission line 100 may increase.

As the data processing speed and the amount of data increase, for example, the power consumed by the second communication module 300 and the data transmission line 100 corresponding to a receiving side may increase more rapidly than the power consumed by the first communication module 200 corresponding to a transmitting side.

Hereinafter, as will be described later with reference to drawings, by applying a current signal-based communication technique between the first communication module 200 and the second communication module 300 to each other, it is possible to reduce the power consumed by the data transmission line 100 by minimizing the amplitude of the voltage signal accompanying the actual signal transmission.

In the present embodiment, the first communication module 200 and the second communication module 300 have the same circuit configuration and are arranged to face each other with respect to the data transmission line 100. The data communication device according to the present invention may perform bidirectional communication. That is, when the first communication module 200 operates in a data transmission mode, the second communication module 300 operates in a data receiving mode. Meanwhile, when the second communication module 300 operates in a data transmission mode, the first communication module 200 operates in a data receiving mode.

The data transmission line 100 may be implemented as a signal pattern on a PCB, a through silicon via (TSV), a through glass via (TGV), etc. Both ends of the data transmission line 100 are connected to the first communication module 200 and the second communication module 300 through I/O pads.

In each data transmission line 100, there is an unintended parasitic capacitance between the virtual GND and the data transmission line 100. In addition, parasitic capacitance also exists between the signal line and the signal line.

This parasitic capacitance consumes a lot of driving power when transmitting high-speed signals. In addition, parasitic capacitance is a major cause of deteriorating the quality of communication signals along with the cause of heat generation problems.

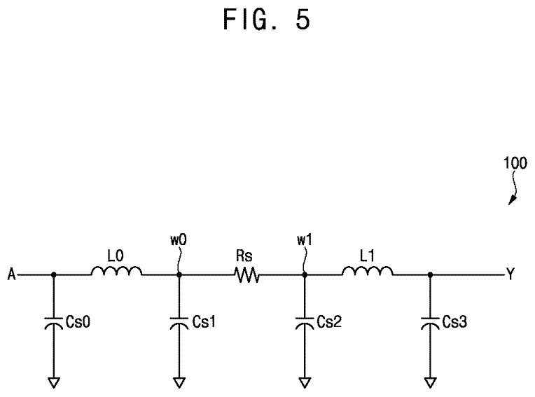

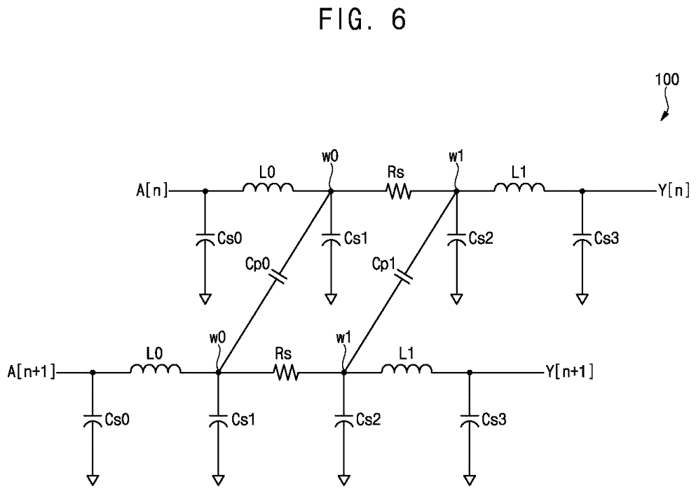

FIG. 5 is a circuit diagram modeling a case in which one data transmission line shown in FIG. 4 is configured. FIG. 6 is a circuit diagram modeling a case in which two data transmission lines shown in FIG. 4 are configured.

Referring to FIG. 4, FIG. 5, and FIG. 6, the data transmission line 100 has a ground GND and a first parasitic capacitive capacitance (CS0, CS1, Cs2, Cs3, hereinafter, Cs), and a second parasitic capacitive coupling capacitance (Cp0, Cp1, hereinafter, Cp) between a plurality of data transmission lines 100.

In the present specification, the first parasitic capacitive capacitance Cs and the second parasitic capacitive coupling capacitance Cp are collectively referred to as capacitive capacitance CIO. The data transmission line 100 theoretically has a DC resistance close to about 0 Ohm, but usually has a series resistance value or impedance value (Rs) of less than 0-300 Ohm. In addition, the data transmission line 100 has values of fine inductance values L0, L1 by a bonding wire, a bump, TSV or other conductive signal path. In addition, one end and the other end of the data transmission line 100 include modeling of an I/O pad that is responsible for input/output with an external device of the semiconductor IC. The model of such a single data transmission line is called a π-model. The components of L0, L1 and Rs are considered very small values and are excluded from an equation, and the Cp values are expressed as one representative value as CIO (Capacity of I/O & I/O line).

The equivalent model of the data transmission line 100 shown in FIG. 5 and FIG. 6 is one of the methods for modeling the electrical characteristics of various data transmission lines, and it is possible to model various types of data transmission lines according to the purpose.

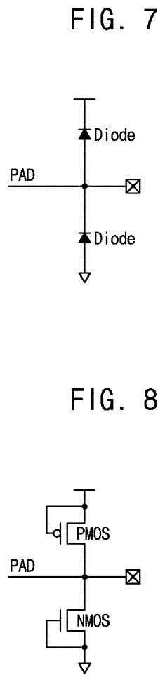

FIG. 7 is a diagram for explaining a configuration of a general I/O pad corresponding to the I/O pad shown in FIG. 4. FIG. 8 is a diagram for explaining an ESD preventing FET structure corresponding to the I/O pad shown in FIG. 4.

Referring to FIG. 7, the I/O pad includes two diodes connected in series. When the I/O pad is connected to the first communication module 200, one diode is ground-connected to the first communication module 200 through a cathode and connected to the first communication module 200 through an anode. Also, the other diode is connected to the first communication module 200 through the cathode and to the first power voltage VDD through the anode. Of course, when the I/O pad is connected to the second communication module 300, one diode is ground-connected to the second communication module 300 through the cathode and connected to the second communication module 300 through the anode. Moreover, the other diode is connected to the second communication module 300 through the cathode and connected to the first power voltage VDD through the anode.

Referring to FIG. 8, an I/O pad includes a MOS connected to two diodes connected in series. When an I/O pad is connected to the first communication module 200, in one MOS, a gate-drain is connected in common to be ground, and is connected to the first communication module 200 through a source. In addition, the other MOS is connected to the first communication module 200 through a drain, and a source-gate is connected in common to be connected to the first power voltage VDD. Of course, when an I/O pad is connected to the second communication module 300, in one MOS, a gate-drain is connected in common to be ground, and is connected to the second communication module 300 through a source. In addition, the other MOS is connected to the second communication module 300 through a drain, and a source-gate is connected in common to be connected to the first power voltage VDD.

Each of the first communication module 200 and the second communication module 300 may include a current conveyor II+ (hereinafter referred to as a current conveyor) as a circuit that converts the input voltage signal into current at transmission and outputs it.

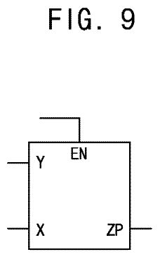

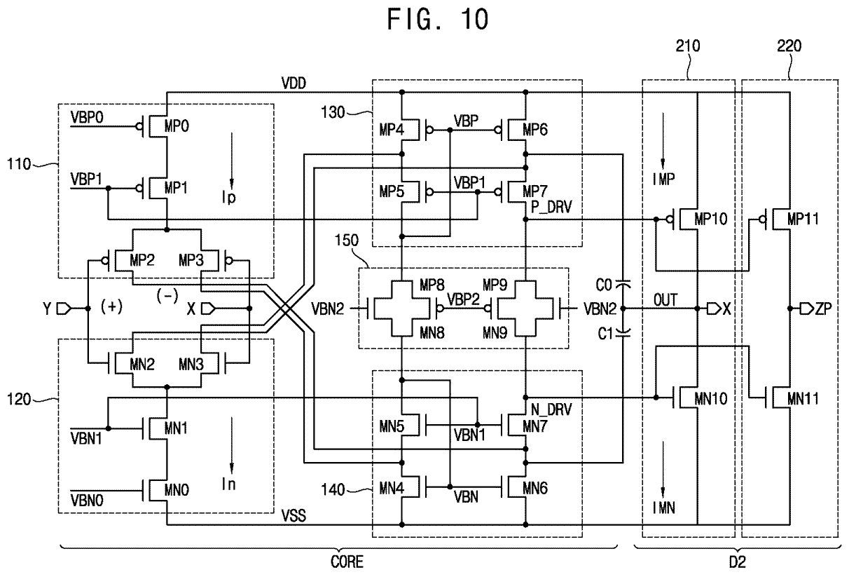

FIG. 9 is a diagram illustrating the symbol of the current conveyor.

Referring to FIG. 9, the current conveyor includes a Y-port that receives a common mode voltage VCOM on a communication line, an X-port that receives a current, and a ZP-port that mirrors and outputs the input current. In addition, the current conveyor includes an enable pin (EN pin) that enables/disables the operating state of the current conveyor.

The relationship between the input signal and the output signal of the current conveyor may be defined by the following matrix.

$$[ \begin{matrix}{i}_{y} \\ {v}_{x} \\ {i}_{\text{?}}\end{matrix} ] = [ \begin{matrix}0 & 0 & 0 \\ 1 & 0 & 0 \\ 0 & + 1 & 0\end{matrix} ] [ \begin{matrix}{v}_{y} \\ {i}_{\text{?}} \\ {v}_{\text{?}}\end{matrix} ] \{ \begin{matrix}{i}_{y} = 0 \\ {v}_{\text{?}} = {v}_{y} \\ {i}_{\text{?}} = + {i}_{\text{?}}\end{matrix}$$

$$\text{?} \text{indicates text missing or illegible when filed}$$

According to the matrix definition of the relationship between the symbol of the current conveyor and the signal input/output shown in FIG. 9, the current conveyor has the following characteristics.
The Y-port is a high impedance port that receives a voltage signal with an input current of “0”.
The X-port is a low impedance port having a voltage equal to that of the Y-port and receiving a current signal.
The ZP-port is a high impedance port that mirrors the input (or output) current of the X-port 1:1 and has the same current output value as the X-port.

FIG. 10 is a circuit diagram explaining the current conveyor according to an exemplary embodiment of the present invention. In the present embodiment, it is shown that the current conveyor is a Balanced Output Rail-to-rail Current Conveyor II.

Referring to FIG. 10, the current conveyor includes a core block CORE and a driving block D2.

The core block CORE includes an upper differential input terminal 110, a lower differential input terminal 120, an upper current mirror terminal 130, a lower current mirror terminal 140, a switching terminal 150, a first capacitor C1, and a second capacitor C2. The core block CORE receives VBP0, VBP1, and VBP2 as bias voltages of PMOS, and receives VBN0, VBN1, and VBN2 as bias voltages of NMOS devices from a bias circuit block (not shown). In the balanced output rail-to-rail second-generation current conveyor shown in FIG. 7, the bias circuit block is omitted.

The core block CORE implements rail-to-rail input/output through the upper differential input terminal 110 and the lower differential input terminal 120 commonly connected to the Y-port and the X-port. The core block CORE mirrors the current applied by the bias voltage based on the voltage at the Y-port and the voltage at the X-port, and applies the first driving voltage P_DRV and the second driving voltage N_DRV to the driving block D2.

The upper differential input terminal 110 includes a p-channel metal-oxide-semiconductor field-effect transistor (MOSFET) MP0 and a p-channel MOSFET MP1 connected in series and a p-channel MOSFET MP2 and a p-channel MOSFET MP3 connected in parallel. The p-channel MOSFET MP0 has a source to which a first power voltage VDD is applied, a gate to which a bias voltage VBP0 is applied, and a drain connected to the source of the p-channel MOSFET MP1. The p-channel MOSFET MP1 has a source connected to the drain of the p-channel MOSFET MP0, a gate to which a bias voltage VBP1 is applied, a source of p-channel MOSFET MP2, and a drain connected to the source of the p-channel MOSFET MP3. The p-channel MOSFET MP2 has a source connected to the drain of the p-channel MOSFET MP1, a gate connected to the Y-port, and a drain connected to the lower current mirror terminal 140. The p-channel MOSFET MP3 has a source connected to the drain of the p-channel MOSFET MP1, a gate connected to the X-port, and a drain connected to the lower current mirror terminal 140. The p-channel MOSFET MP2 and p-channel MOSFET MP3 are responsible for input. The p-channel MOSFET MP2 and p-channel MOSFET MP3 compare the voltage of the Y-port and the voltage of the X-port to pass a tail current Ip applied by a bias voltage toward a gate to which a lower voltage is input. Here, a range of an operable input signal voltage (that is, a common mode voltage) is about 2.5V to about 0V, assuming that a first power voltage VDD is about 3.3V.

The lower differential input terminal 120 includes an n-channel MOSFET MN0 and an n-channel MOSFET MN1 connected in series and an n-channel MOSFET MN2 and an n-channel MOSFET MN3 connected in parallel. The n-channel MOSFET MN0 has a drain connected to the source of the n-channel MOSFET MN1, a gate to which a bias voltage VBN0 is applied, and a source to which a second power voltage VSS is applied. The n-channel MOSFET MN1 has a drain connected to a source of the n-channel MOSFET MN2 and the source of the n-channel MOSFET MN3, a gate to which a bias voltage VBN1 is applied, and a source connected to the drain of the n-channel MOSFET MN0. The n-channel MOSFET MN2 has a drain connected to the upper current mirror end 130, a gate connected to the Y-port, and a source connected to the drain of the n-channel MOSFET MN1. The n-channel MOSFET MN3 has a drain connected to the upper current mirror terminal 130, a gate connected to the X-port, and a source connected to the drain of the n-channel MOSFET MN1. The n-channel MOSFET MN2 and n-channel MOSFET MN3 are responsible for the input. The n-channel MOSFET MN2 and n-channel MOSFET MN3 compare the voltage of the Y-port and the voltage of the X-port to pass the current ‘In’ applied by a bias voltage toward the gate to which the higher voltage is input. Here, a range of an operable input signal voltage (that is, a common mode voltage) is about 0.7V to about 3.3V, assuming that a first power voltage VDD is about 3.3V.

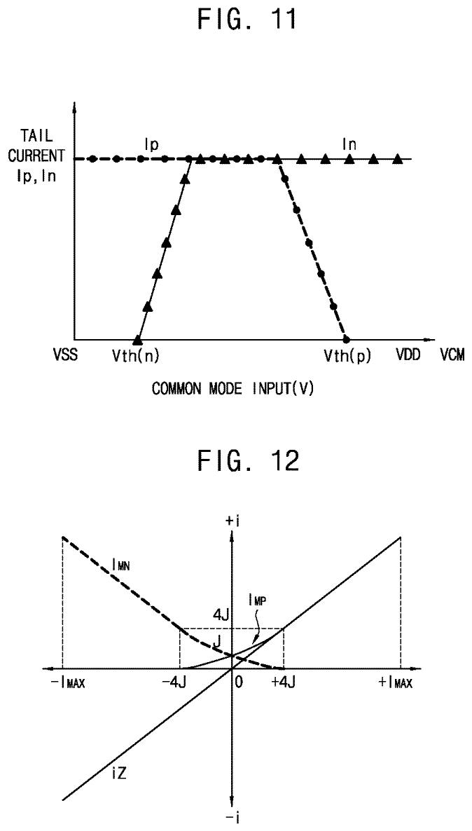

Since an upper differential input terminal 110 and a lower differential input terminal 120 are disposed as input stages of the current conveyor, rail-to-rail input may be implemented. That is, when a power supply is about 3.3V, the tail currents ‘Ip’ and ‘In’ may be supplied so that a range of the common mode voltage covers all of the range of the first power voltage VDD. The range of the input voltage may be expressed as shown in FIG. 11.

FIG. 11 is a graph explaining a rail-to-rail input.

As shown in FIG. 11, since the rail-to-rail input covers all of the range of the input signal, 0V to VDD, it may operate with a wider range of input voltage compared to a case where a conventional circuit receives an upper input or a lower input.

Referring again to FIG. 10, the upper current mirror stage 130 includes a p-channel MOSFET MP4, a p-channel MOSFET MP5, a p-channel MOSFET MP6, and a p-channel MOSFET MP7 to define the current mirror. The p-channel MOSFET MP4 has a source to which a first power voltage VDD is applied, a gate connected to a drain of the p-channel MOSFET MP5 and a gate of the p-channel MOSFET MP6, and a drain connected to a source of the p-channel MOSFET MP5. Further, the drain of the p-channel MOSFET MP4 is connected to a source of the n-channel MOSFET MN3 of the lower differential input terminal 120. The p-channel MOSFET MP5 has a source connected to the drain of the p-channel MOSFET MP4, a gate connected to a gate of the p-channel MOSFET MP7, and a drain connected to the gate of the p-channel MOSFET MP4. Further, the source of the p-channel MOSFET MP5 is connected to the source of the n-channel MOSFET MN3 of the lower differential input terminal 120. The p-channel MOSFET MP6 has a source to which a first power voltage VDD is applied, a gate connected to the drain of the p-channel MOSFET MP5 and the gate of the p-channel MOSFET MP4, and a drain connected to a source of the p-channel MOSFET MP7. Further, the drain of the p-channel MOSFET MP6 is connected to a source of the n-channel MOSFET MN2 of the lower differential input terminal 120. The p-channel MOSFET MP7 has a source connected to the drain of the p-channel MOSFET MP6, a gate connected to the gate of the p-channel MOSFET MP5, and a drain connected to a driving block D2 and the switching terminal 150. Here, the p-channel MOSFET MP5 and p-channel MOSFET MP7 are biased by a bias voltage VBP1, and the drain voltage of the p-channel MOSFET MP5 is applied to the p-channel MOSFET MP4 and p-channel MOSFET MP6 as a bias voltage.

When a gate size of the p-channel MOSFET MP4 and a gate size of the p-channel MOSFET MP6 are equal to each other, and a gate size of the p-channel MOSFET MP5 and a gate size of the p-channel MOSFET MP7 are equal to each other, a current flowing through the p-channel MOSFET MP6 and p-channel MOSFET MP7 is equal to a current flowing through the p-channel MOSFET MP4 and p-channel MOSFET MP5. At this time, a saturation voltage of the p-channel MOSFET MP5 is higher than a threshold voltage (Vth) of the p-channel MOSFET MP4, thereby supplying current to the drain of the p-channel MOSFET MP7. Therefore, a range of an operating voltage is wider than that of a general structure of a current mirror.

When a current is applied at different values to each of the drains of the p-channel MOSFET MP4 and p-channel MOSFET MP6 due to the difference in the input voltage of the lower differential input terminal 120, the final output current I(MP7) flowing through the p-channel MOSFET MP7 is determined by the bias current of ±@IN by a bias voltage VBP1. Here, @ is a ratio of the current ‘In’ to a difference value of an input voltage obtained from the upper differential input terminal 110 and the lower differential input terminal 120, which are input stages of the current conveyor.

The lower current mirror stage 140 includes an n-channel MOSFET MN4, an n-channel MOSFET MN5, an n-channel MOSFET MN6, and an n-channel MOSFET MN7 to define the current mirror. The n-channel MOSFET MN4 has a drain connected to a source of the n-channel MOSFET MN5, a gate connected to a gate of the n-channel MOSFET MN6, and a source to which a second power voltage VSS is applied. Further, the drain of the n-channel MOSFET MN4 is connected to the source of the p-channel MOSFET MP3 of the upper differential input terminal 110. The n-channel MOSFET MN5 has a drain connected to the switching terminal 150, a gate connected to a gate of the n-channel MOSFET MN7, and a source connected to the drain of the n-channel MOSFET MN4. Further, the source of the n-channel MOSFET MN5 is connected to the source of the p-channel MOSFET MP2 of the upper differential input terminal 110. The n-channel MOSFET MN6 has a drain connected to a source of the n-channel MOSFET MN7, a gate connected to the gate of the n-channel MOSFET MN4, and a source to which a second power voltage VSS is applied. The n-channel MOSFET MN7 has a drain connected to the switching terminal 150, a gate connected to the gate of the n-channel MOSFET MN5, and a source connected to the drain of the n-channel MOSFET MN6. Further, the drain of the n-channel MOSFET MN7 is connected to the source of the p-channel MOSFET MP2 of the upper differential input terminal 110. Here, the n-channel MOSFET MN5 and n-channel MOSFET MN7 are biased with a bias voltage VBN1, and the source voltage of the n-channel MOSFET MN5 is applied as bias voltages of the n-channel MOSFET MN4 and n-channel MOSFET MN6.

When a gate size of the n-channel MOSFET MN4 and a gate size of the n-channel MOSFET MN6 are equal to each other, and a gate size of the n-channel MOSFET MN5 and a gate size of the n-channel MOSFET MN7 are equal to each other, a current flowing through the n-channel MOSFET MN6 and n-channel MOSFET MN7 is equal to a current flowing through the n-channel MOSFET MN4 and n-channel MOSFET MN5. At this time, a saturation voltage of the n-channel MOSFET MN5 is higher than a threshold voltage (Vth) of the n-channel MOSFET MN4, thereby supplying current to the drain of the n-channel MOSFET MN7. Therefore, a range of an operating voltage is wider than that of a general structure of a current mirror.

At this time, when current is applied at different values to each sources of the n-channel MOSFET MN4 and n-channel MOSFET MN6 due to the difference in the input voltage of the upper differential input terminal 110, the final output current I(MN7) flowing through the n-channel MOSFET MN7 is determined by the bias current of +@IP by a bias voltage VBN1. Here, @ is a ratio of the current (Ip) to a difference value of an input voltage obtained from the upper differential input terminal 110 and the lower differential input terminal 120, which are input stages of the current conveyor.

In the present embodiment, the upper current mirror stage 130 and the lower current mirror stage 140 employ a high-compliance current mirror.

The driving block D2 includes a first driver 210 and a second driver 220, and outputs a normal output current through the ZP-port in response to the first driving voltage P_DRV and the second driving voltage N_DRV.

The first driver 210 includes a p-channel MOSFET MP10 and an n-channel MOSFET MN10 connected in series. The p-channel MOSFET MP10 has a source to which a first power voltage VDD is applied, a gate connected to the upper current mirror terminal 130, and a drain connected to a drain of the n-channel MOSFET MN10 and a drain connected to the X-port. The n-channel MOSFET MN10 has a source to which a second power voltage VSS is applied, a gate connected to the lower current mirror terminal 140, and a drain connected to a drain of the p-channel MOSFET MP10 and the X-port. The first driver 210 performs the role of connecting the output to the X-port of the input stage to fit the structure of a second-generation current conveyor.

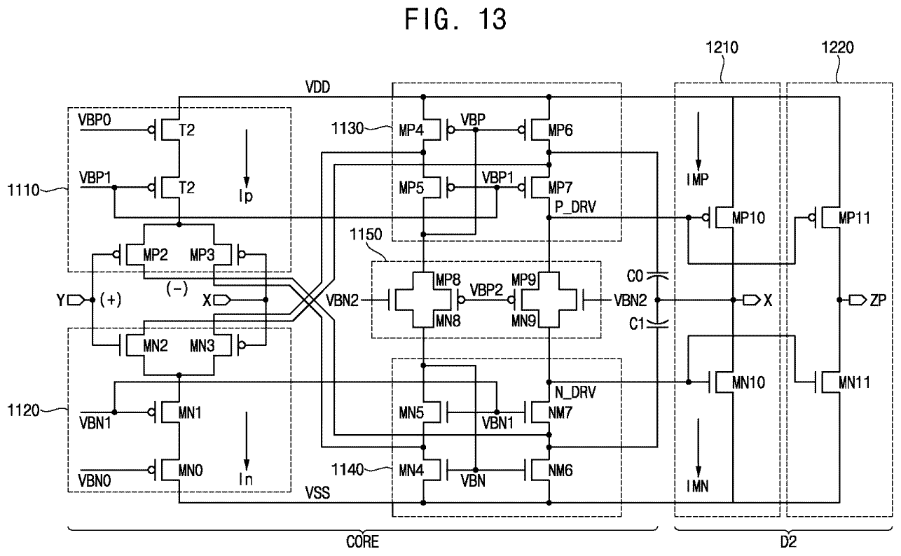

FIG. 12 is a graph explaining current characteristics of p-channel MOSFET MP10 and n-channel MOSFET MN10 provided in the first driver 210 shown in FIG. 9A.

As shown in FIG. 12, the output current IMP of the p-channel MOSFET MP10 is controlled by the first driving voltage P_DRV, which is the output of the upper current mirror stage 130. The p-channel MOSFET MP10 operates in a linear mode in a section where the output current IMP is greater than +4J, and has a nonlinear characteristic in a section where the output current IMP is less than +4J. The p-channel MOSFET MP10 is cut-off in a period of −4J or less so that it cannot drive current anymore. Here, J denotes a standby mode current (i.e., a value of a current flowing before operation in a standby state) as a quiescent current of a driving MOSFET. Class AB drivers are designed by defining the section of the bias voltage before the gate voltage of each driver MOS passes the threshold voltage and reaches the linear operation mode as a section of about ±4J.

Meanwhile, the output current IMN of the n-channel MOSFET MN10 is controlled by the second driving voltage N_DRV, which is the output of the lower current mirror stage 140. The n-channel MOSFET MN10 operates in a linear mode in a section where the output current I_{MN} is less than −4J, and the n-channel MOSFET MN10 has a nonlinear characteristic in a section greater than −4J. The n-channel MOSFET MN10 is cut-off in a section of +4J or more, so it cannot drive current any more.

Therefore, the current values of the p-channel MOSFET MP10 and n-channel MOSFET MN10 exist in zero current section without signal (i.e., no signal section), but have the smallest current values in an operation mode, so this this output buffer stage is called a class AB stage. A driver with this function is called a Class AB driver. In addition, by using a current conveyor with such a class AB driver, it is possible to reduce the current consumption when there is no signal. Moreover, the size of the output driver is appropriately adjusted to suit the application, and it is possible to drive low-power operation characteristics and drive a large current.

Referring back to FIG. 10, the second driver 220 includes a p-channel MOSFET MP11 and an n-channel MOSFET MN11 connected in series in the same manner as the structure of the first driver 210. The p-channel MOSFET MP11 has a source to which a first power voltage VDD is applied, a gate connected to the gate of the p-channel MOSFET MP10 of the first driver 210, and a drain connected to a drain of the n-channel MOSFET MN11 and the ZP-port. The n-channel MOSFET MN11 has a source to which a second power voltage VSS is applied, a gate connected to the lower current mirror terminal 140 and the gate of the n-channel MOSFET MN10, and a drain connected to the drain of the p-channel MOSFET MP11 and the ZP-port. Unlike the first driver 210 being connected to the X-port of the differential input stage of the upper differential input terminal 110 and the lower differential input terminal 120, the second driver 220 is connected to the ZP-port for output driving.

In FIG. 10, the driving block D2 and the first driver 210 of the core block CORE are a circuit structure of a general folded cathode OPAMP having a rail-to-rail input and output. The p-channel MOSFET MP11 and the transistor NM11, which define the second driver 220 of the driving block D2, are MOSFETs added to make OPAMP a current conveyor.

The Y-port is connected to the positive input terminal (+) of the OPAMP, and the X-port is electrically connected by shorting the negative input terminal (−) and the output terminal OUT of the OPAMP.

The gate input signal of p-channel MOSFET MP10 of the first driver 210 for high-level output of the OPAMP is connected to the gate of p-channel MOSFET MP11 of the second driver 220 for high-level output of the ZP-port. Furthermore, the gate input signal of n-channel MOSFET MN10 of the first driver 210 for low-level output of the OPAMP is connected to the gate of n-channel MOSFET MN11 of the second driver 220 for high-level output of the ZP-port.

In order to satisfy the characteristics of the ZP-port among the matrix relational expressions defining the current conveyor, in this embodiment, the p-channel MOSFET MP10 and the p-channel MOSFET MP11, and the n-channel MOSFET MN10 and the n-channel MOSFET MN11 may include MOSFETs having the same channel length and channel width, respectively.

In actual commercial circuit configurations, each MOSFET may be implemented with a current mirroring ratio of 1:N (where, N is a positive prime number greater than 0 and less than 2) in the current conveyors on the transmitting unit and receiving unit sides to reflect the characteristics of the data transmission line to transmit or receive signals on the data transmission line. The signal is intentionally enlarged or distorted to pre-emphasize the signal to reflect the characteristics of the communication line at the transmitting side, and equalizing technology is applied to improve the SNR and facilitate the judgment of the signal at the receiving side.

FIG. 13 is a circuit diagram for explaining a current conveyor according to another example.

Referring to FIG. 13, the current conveyor CC includes a core block CORE and a driving block D2.

Since the core block CORE is the same as the core block CORE shown in FIG. 10, the same reference numerals are assigned and the detailed description thereof is omitted.

The driving block D2 includes a first driver 1210 and a second driver 2220, and outputs a first normal output current and a second normal output current through each of the first ZP-port IZPP and the second ZP-port IZPN in response to the first driving voltage P_DRV and the second driving voltage N_DRV.

The first driver 1210 includes a p-channel MOSFET MP10 and an n-channel MOSFET MN10 connected in series. The p-channel MOSFET MP10 has a source to which a first power supply voltage VDD is applied, a gate connected to the upper current mirror terminal 1130, and a drain of the n-channel MOSFET MN10 and a drain connected to the X-port. The n-channel MOSFET MN10 has a source to which a second power supply voltage VSS is applied, a gate connected to a lower current mirror terminal 1140 and a drain of the p-channel MOSFET p-channel MOSFET MP10 and the X-port. The first driver 1210 connects an output to the X-port of the input stage to fit the structure of the second generation current conveyor.

The second driver 2220 includes a p-channel MOSFET MP11, an n-channel MOSFET MN11, a p-channel MOSFET MP12, a p-channel MOSFET MP13, an n-channel MOSFET MN12, and an n-channel MOSFET MN13. The p-channel MOSFET MP11 and the n-channel MOSFET MN11 are connected in series in the same way as the structure of the first driver 1210. The p-channel MOSFET MP12 and the p-channel MOSFET MP13 are connected to n-channel MOSFET MN11 to output the first normal output current through the first ZP-port (IZPP). The n-channel MOSFET MN12 and the n-channel MOSFET MN13 are connected to p-channel MOSFET MP11 to output second normal output current through the second ZP-port IZPN.

The p-channel MOSFET MP11 has a source to which the VDD is applied, a gate commonly connected to the gate of the upper current mirror terminal 1130, and the gate of the p-channel MOSFET MP10, and a drain connected to the source of the n-channel MOSFET MN12. The n-channel MOSFET MN11 has a source to which the VSS is applied, a gate commonly connected to the gate of the lower current mirror terminal 1140 and the gate of the n-channel MOSFET MN10, and a drain connected to the drain of the p-channel MOSFET MP12.

The p-channel MOSFET MP12 has a source to which the VDD is applied, a gate and a drain commonly connected to the source of the n-channel MOSFET MN11. The p-channel MOSFET MP13 has a source to which the VDD is applied, a gate of the p-channel MOSFET MP12, and a drain connected to the first ZP-port. The p-channel MOSFET MP12 and the p-channel MOSFET MP13 function as a current mirror to source the current.

The n-channel MOSFET MN12 has a source connected to the drain of the p-channel MOSFET MP11, a gate connected in common to the source and connected to the drain of the p-channel MOSFET MP11, and a drain connected to the VSS. The n-channel MOSFET MN13 has a source connected to the second ZP-port, a gate connected to the gate of the n-channel MOSFET MN12, and a drain connected to the VSS. The n-channel MOSFET MN12 and the n-channel MOSFET MN13 function as a current mirror to sink the current.

In FIG. 13, the first driver 1210 is connected to the X-port of the differential input stage of the upper differential input terminal 1110 and the lower differential input terminal 1120. However, the second driver 2220 is connected to the first ZP-port IZPP and the second ZP-port IZPN for output driving.

In FIG. 10 and FIG. 13, a folded cascode OPAMP circuit with rail-to-rail input and output is shown as an OPAMP that can be used as a current conveyor, but it is possible to design a current conveyor with the same function even if a traditional current conveyor or a circuit structure such as cascode OPAMP, telescopic OPAMP, and two-stage OPAMP is used.

In the present embodiment, the first communication module 200 and the second communication module 300 are arranged to face each other with respect to the data transmission line 100 and have the same components on a circuit. Therefore, since the description of the second communication module 300 may be easily derived from the description of the first communication module 200, the first communication module 200 is mainly described in the following.

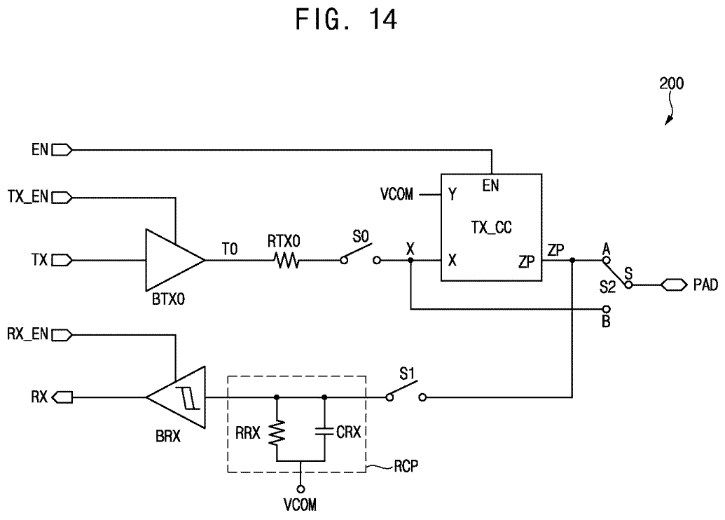

FIG. 14 is a diagram for explaining an example of a first communication module shown in FIG. 4.

Referring to FIG. 4 and FIG. 14, the first communication module 200 includes a TX buffer BTX0, a TX resistor RTX0, a TX switch S0, a TX current conveyor TX_CC, a mode switching switch S2, an RX switch S1, an RC parallel circuit RCP, and an RX buffer BRX, and converts an input voltage signal into a current and provides it to the transmission line 100.

The TX buffer BTX0, the TX resistor RTX0, the TX switch S0, the TX current conveyor TX_CC, and the mode switching switch S2 are connected in series with the TX current conveyor TX_CC.

The TX current conveyor TX_CC includes an EN-port to which an EN signal is input, a Y-port to which a common mode voltage VCOM is input, an X-port connected to the TX switch S0, and a ZP-port connected to the mode switching switch S2. In the present embodiment, the common mode voltage VCOM may be equal to ½ of the first power voltage VDD.

The mode switching switch S2 has a first terminal A, a second terminal B and a third terminal S. In this case, when the first terminal A and the third terminal S are connected, the ZP-port of the TX current conveyor TX_CC and the I/O pad are connected. Also, when the second terminal B and the third terminal S are connected, the ZP-port of the TX current conveyor TX_CC and the X-port of the TX current conveyor TX_CC are connected.

The RX switch S1 is connected between the ZP-port of the TX current conveyor TX_CC and the RC parallel circuit RCP. The RC parallel circuit RCP includes a resistor and a capacitor connected in parallel, one end is connected to the RX switch S1 and the RX buffer BRX, and the other end is connected to the common mode voltage VCOM. The RX buffer BRX is connected to the RC parallel circuit RCP to output an RX signal. In the present embodiment, the RC parallel circuit RCP is shown between the RX switch S1 and the RX buffer BRX, but the resistor element alone may be disposed between the RX switch S1 and the RX buffer BRX.

In the present embodiment, the TX buffer BTX0 is enabled according to the TX_EN signal to provide the TX signal to the TX resistor RTX0. An operating voltage of the TX buffer BTX0 is a first power voltage VDD. The TX resistor RTX0 is disposed between the TX buffer BTX0 and the X-port of the TX current conveyor TX_CC, so that the voltage of the TX signal, which is a logic signal, may be easily converted into two types of currents applied to the X-port of the TX current conveyor TX_CC. That is, with respect to values of 0, which are logic signal voltages, the values of current −1, +1 of relative magnitudes may be applied to the X-port of the TX current conveyor TX_CC.

When a power source of a logic core that generates a transmission signal and a voltage of an interface power source for signal transmission are different from each other, or when different voltages should be used for the quality of a communication signal, the TX buffer BTX0 may use a buffer including a voltage level shifter. An operating voltage of the voltage level shifter is a first power voltage VDD.

In this case, when the value of the TX resistor RTX0 is RTX, the voltage of the TX buffer BTX0 is a first power voltage VDD, the common mode voltage VCOM is ½VDD, and the value of the TX buffer BTX0 is 1, the current applied to the X-port of the TX current conveyor TX_CC is shown in Equation (2) below.

$$I = \frac{( VDD - VCOM )}{RTX} \qquad [ Equation 2 ]$$

On the other hand, when the value of the TX buffer BTX0 is 0, the current applied to the X-port of the TX current conveyor TX_CC is shown in Equation (3) below.

$$I = \frac{( 0 - VCOM )}{RTX} \qquad [ Equation 3 ]$$

Since the common mode voltage VCOM is ½VDD, the current is (½VDD)/RTX and −(/2VDD) RTX, respectively. When expressed as a relative size, it may be expressed as +1 and −1, respectively.

When the TX buffer BTX0 is disabled, the output of the TX buffer BTX0 is floated and the value of the current applied to the X-port of the TX current conveyor TX_CC is “0”. In addition, the value of the current mirrored to the ZP-port of the TX current conveyor TX_CC is also “0”. When this signal state is also applied to the data transmission line 100, it has a value of a relative size of “0”.

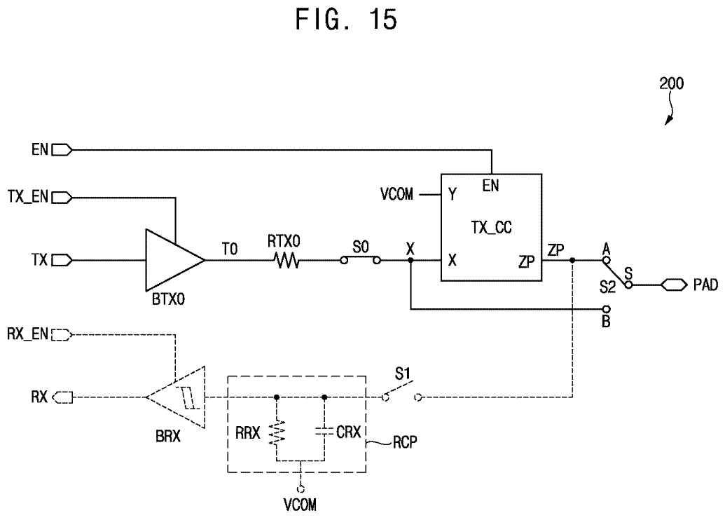

FIG. 15 is a circuit diagram for explaining that the first communication module shown in FIG. 14 operates in a data transmission mode. In FIG. 15, an operating part is indicated by a solid line, and a non-operating part is indicated by a dotted line.

Referring to FIG. 4, FIG. 14 and FIG. 15, for a data transmission mode, an EN signal and a TX_EN signal are activated to “1” and a RX_EN signal is deactivated to “0”. In this case, the TX switch S0 is turned-on, the RX switch S1 is turned-off, and the third terminal S of the mode switching switch S2 is connected to the first terminal A.

The TX signal is input to the X-port of the current conveyor TX_CC via a TX buffer BTX0, a T-node T0, a TX resistor RTX0, and a TX switch S0. The ZP-port of the current conveyor TX_CC is connected to the I/O pad via a mode switching switch S2 to transmit a signal.

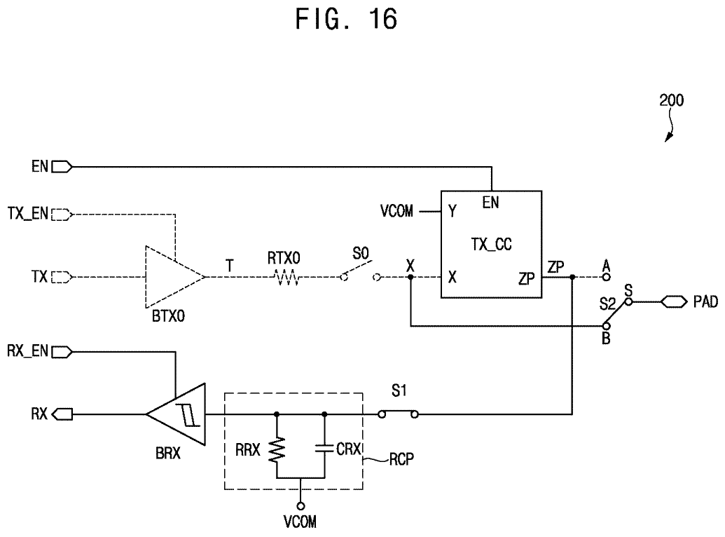

FIG. 16 is a circuit diagram for explaining that the first communication module shown in FIG. 14 operates in a data receiving mode. In FIG. 16, an operating part is indicated by a solid line, and a non-operating part is indicated by a dotted line.

Referring to FIG. 4, FIG. 14 and FIG. 16, for a data receiving mode, an EN signal and a RX_EN signal are activated to “1” and a TX_EN signal is deactivated to “0”. In this case, the TX switch S0 is turned-off, the RX switch S1 is turned-on, and the third terminal S of the mode switch S2 is connected to the second terminal B.

The received signal input through the I/O pad is input to the X-port of the current conveyor TX_CC through the mode change switch S2. The ZP-port of the current conveyor TX_CC is connected to the RX buffer BRX through the RX switch S1 to receive a signal.

As described above, when the first transmission signal TX_A is provided to the first communication module 200 from the external device (not shown), the first communication module 200 converts the first transmission signal TX_A into the first transmission current and outputs the first transmission current to one end of the data transmission line 100.

The second communication module 300 provides a first reception current having the same level as the first transmission current input through the data transmission line 100 and opposite signs (phase is 180 degrees) to the data transmission line 100. A current input from one end of the data transmission line 100 and a current input from the other end of the data transmission line 100 cancel each other. Accordingly, the voltage change between the data transmission lines 100 generated during signal transmission is controlled to be about 0V theoretically, several mVs for a short time, or tens of mVs or less in actual implementation. Simultaneously, the second communication module 300 mirrors the first reception current and outputs a reception signal at the first reception voltage to restore the transmission signal.

Meanwhile, when a second transmission signal TX_B is provided to the second communication module 300 from an external device (not shown), the second communication module 300 converts the second transmission signal TX_B into a second transmission current and outputs the second transmission current to the other end of the data transmission line 100.

The first communication module 200 provides a second reception current having the same level as the second transmission current input through the data transmission line 100 and opposite sign (phase is 180 degrees) to the data transmission line 100. A current input from one end of the data transmission line 100 and a current input from the other end of the data transmission line 100 cancel each other. Accordingly, the voltage change between the data transmission lines 100 generated during signal transmission is controlled to be about 0V theoretically, several mVs for a short time, or tens of mVs or less in actual implementation. Simultaneously, the first communication module 200 mirrors the second reception current and outputs a reception signal at the second reception voltage to restore the transmission signal.

In the present embodiment, the reason why the current input from one end of the data transmission line 100 and the current input from the other end of the data transmission line 100 cancel each other out from a voltage and current point of view is explained.

First, from a voltage point of view, the current conveyor includes an OPAMP circuit (shown in FIG. 10 as the first driver 210 of the core block CORE and the driving block D2) which controls a voltage of the X-port to be the same as that of the Y-port as described above. When the voltage of the X-port differs from that of the Y-port by the current applied to the X-port during the operation of the OPAMP circuit, the OPAMP circuit within the current conveyor detects it and immediately supplies or consumes the current so that the voltage of the X-port is the same as the voltage of the Y-port. Due to this function, the voltage of the X-port is offset by the same value regardless of the value of the current input to the X-port, so that the voltage of the Y-port may be kept constant.

On the other hand, from a current flow point of view, when a current is applied to the X-port of the current conveyor, the current temporarily attempts to raise or lower the voltage of the X-port. When the voltage of the X-port differs from the voltage of the Y-port during this process, the OPAMP circuit inside the current conveyor detects it and immediately performs the function of immediately taking out or supplying the required current to the X-port so that the voltage of the X-port and the voltage of the Y-port become the same. Because of this function, the current is offset, the voltage of the X-port remains the same as that of the Y-port.

In each of the first communication module 200 and the second communication module 300, various methods may be employed in addition to a method of using a current conveyor as a circuit for converting an externally input voltage signal into a current.

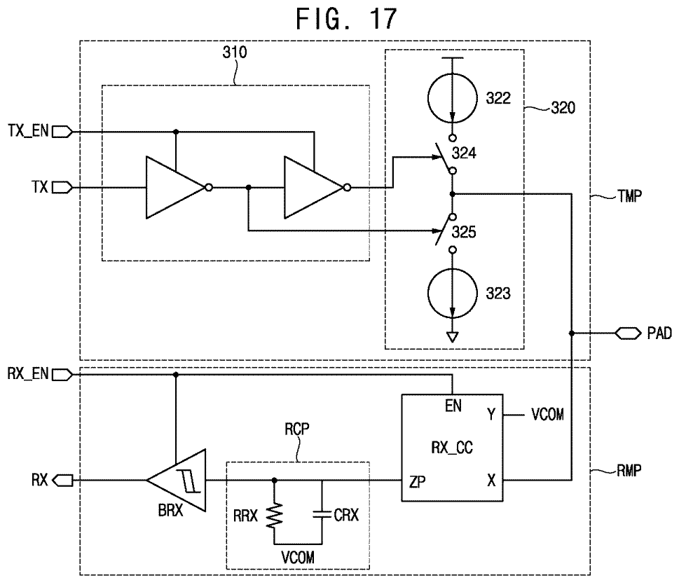

FIG. 17 is a diagram for explaining another example of the first communication module shown in FIG. 4. In particular, a first communication module 200 including a voltage-to-current converter that replaces a current conveyor in data transmission mode is illustrated.

Referring to FIG. 17, the first communication module 200 includes a transmission mode unit TMP and a reception mode unit RMP.

The transmission mode unit TMP includes a first buffer 310 and a voltage-to-current converter 320, converts an externally input voltage level TX signal to current, and outputs the current to the data transmission line 100 through the I/O pad.

Specifically, the first buffer 310 includes a pre-inverter and a post-inverter connected to a rear end of the pre-inverter. The pre-inverter is enabled by the TX_EN signal to invert the TX signal, and the post-inverter inverts the signal enabled by the pre-inverter.

The voltage-to-current converter 320 includes a pull-up current source 322, a pull-down current source 323, a pull-up switch 324, and a pull-down switch 325. The pull-up current source 322 and the pull-down current source 323 generate a first current. The pull-up current source 322 and the pull-down current source 323 may include a current source or a current mirror. The pull-up switch 324 controls the output of the first current generated in the pull-up current source 322 in response to a signal output from the rear inverter of the first buffer 310. The pull-down switch 325 controls the output of the first current generated in the pull-down current source 323 in response to a signal output from the front inverter of the first buffer 310.

Accordingly, the current corresponding to the transmission voltage signal, i.e., the first current, is applied to the data transmission line 100 connected through the I/O pad. That is, in order to convert the input voltage signal into current, a current switch 324 and a pull-down switch 325 connected to the pull-up current source 322 and the pull-down current source 323 may be used.

The reception mode unit RMP includes an RX current conveyor RX_CC, an RC parallel circuit RCP, and an RX buffer BRX, and converts a reception current input from the data transmission line 100 connected through the I/O pad into a voltage level RX signal.

Specifically, the RX current conveyor RX_CC includes an EN-port to which an RX_EN signal is applied, a Y-port to which a common mode voltage VCOM is applied, an X-port connected to a data transmission line 100 through an I/O pad, and a ZP-port connected to an RC parallel circuit RCP. In the transmission mode, when the TX_EN signal becomes a high level and the RX_EN signal becomes a low level, the X-port of the RX current conveyor RX_CC becomes a high-Z state and does not affect the transmission operation. In the reception mode, when the TX_EN signal becomes a low level and the RX_EN signal becomes a high level, the output of the current source becomes a high-Z state and does not affect the X-port input of the RX current conveyor RX_CC.

The RC parallel circuit RCP includes a resistor RRX and a capacitor CRX connected in parallel, and receives the received current output through the ZP-port of the RX current driver RX_CC and charges it to form a received voltage.

The RX buffer BRX is enabled by the RX_EN signal and outputs a received voltage formed by the RC parallel circuit RCP to the outside through the RX terminal.

As described above, according to the first communication module 200 described with reference to FIG. 17, the TX switch S0, the RX switch S1, and the mode switching switch S2 may be removed from the first communication module 200 described with reference to FIG. 14 or FIG. 16. In addition, the current source is involved only in a data transmission mode, and the RX current conveyor RX_CC is involved only in a data receiving mode, and thus may be applied.

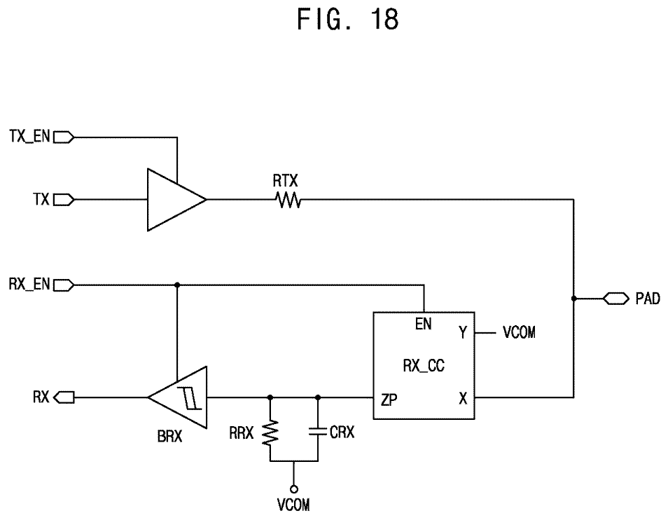

FIG. 18 is a circuit diagram for explaining another application example in which the voltage-to-current converters 310 and 320 of FIG. 17 are replaced with a buffer and a resistor.

Referring to FIG. 18, switches are removed and the current conveyor is used only for signal reception in FIG. 17. A resistor is connected to one end of the buffer receiving the TX signal, and the other end is directly connected to the PAD connected to the data transmission line. The high or low voltage output of the buffer is converted into a pull-up or pull-down current signal through a TX resistor RTX.

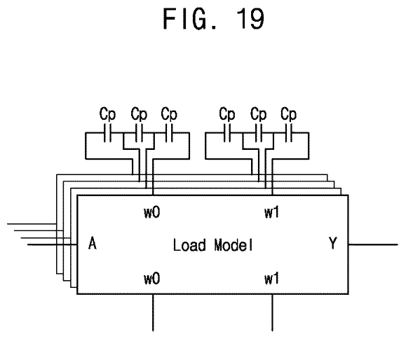

FIG. 19 is a diagram for explaining an example of implementing four data transmission lines shown in FIG. 4.

Referring to FIG. 19, the Cp existing between the data transmission lines 100 refers to the parasitic capacitance existing between the conductor data transmission lines facing each other while the adjacent data transmission lines 100 are disposed in a plane or space. Actually, it depends on the structure and width of the wiring, but in the present specification, it is collectively referred to as a Cp value.

FIG. 20 is a circuit diagram for explaining an example of the data communication device shown in FIG. 4.

Referring to FIG. 19, the first communication module 200 and the second communication module 300 are connected to each other through one data transmission line 100.

The first communication module 200 is configured to transmit a signal, and the second communication module 300 is configured to receive the signal. The capacitive load of one data transmission line 100 is collectively referred to as a CIO and is briefly defined to describe the signal transmission process.

The reference numeral D_TX is a port for receiving a signal to be transmitted from a logic circuit as a port for receiving a signal to be transmitted.

The TX buffer BTX is responsible for outputting the value of signal 1 or 0 to be transmitted from the logic circuit as low impedance (i.e., low Ron resistance) using MOSFET connected to the first power voltage VDD and a ground GND.

An output current of the TX buffer BTX may be formed of a MOSFET having an ON resistance of at least 1/10 of the resistance value of the TX resistor RTX. An output terminal of the TX buffer BTX is connected to one end of the TX resistor RTX. Even when the voltage of node b connected to the other end of the TX resistor RTX has the common mode voltage VCOM, the TX buffer BTX has sufficient driving capability (or ON resistance sufficiently small compared to the TRX). Therefore, when the TX buffer BTX is driven, the “L” signal approaches 0V and the “H” signal approaches the first power voltage VDD, the better the signal transmission characteristics.

However, in order to reduce the ON resistance, the gate area is increased. Since the increased gate area increases the gate capacitance, it negatively affects the operating speed and power consumption. Therefore, the MOSFET constituting the TX buffer BTX, in particular, the output MOSFET, should be delicately determined in size to suit the system characteristics.

In addition, when the operating voltage of the logic circuit (usually called the core voltage) and the first power voltage VDD to be used for signal transmission are not the same, the TX buffer (BTX) may include a voltage level shifter with a voltage level conversion function.

FIG. 21 is a circuit diagram for explaining an example of a TX buffer shown in FIG. 20.

Referring to FIG. 20 and FIG. 21, in the TX buffer BTX, MOSFET P0 and MOSFET N0 define a primary inverter-buffer for primary inverting and buffering an input value of a logic value. In addition, in the TX buffer BTX, MOSFET P1 and MOSFET N1 define a secondary inverter-buffer using a large FET having a larger channel width of a gate and a lower ON resistance than MOSFET P0 and MOSFET N0.

The TX buffer BTX of the first communication module 200 may have a control signal enable pin (i.e., an EN pin) for enabling/disabling an operation state or the current value to be output is 0 (i.e., high impedance, Hi-Z).

FIG. 22 is a circuit diagram for explaining another example of the TX buffer shown in FIG. 20. In particular, an example in which an enable pin EN is added to a TX buffer BTX is illustrated.

Referring to FIG. 20 and FIG. 22, when the enable pin EN is in the “0” state, the GP signal generates a High (i.e., “1”) state regardless of the input transmission signal IN to bring the MOSFET P0 to the OFF state. The GN signal generates a Low (i.e., “0”) to bring the MOSFET N0 to the OFF state and block the output of the TX buffer BTX.

On the other hand, when the enable pin EN is in the “1” state, the output of the OUT is controlled in the same phase according to the signal of the data input IN.

The 3-input NOR gate and the 3-input NAND gate have a latch structure in which each output is connected to the input of the other side. When MOSFET P0 and MOSFET N0 switch at high speed, MOSFET P0 and MOSFET N0 are turned-on for a brief period. This is due to a mismatch between the rising and falling delays of the GP and GN signals. Concurrently, they perform a function of generating a non-overlap gate control signal for the GP and GN signals. This prevents short current from occurring in the direction of the ground GND from the first power voltage VDD.

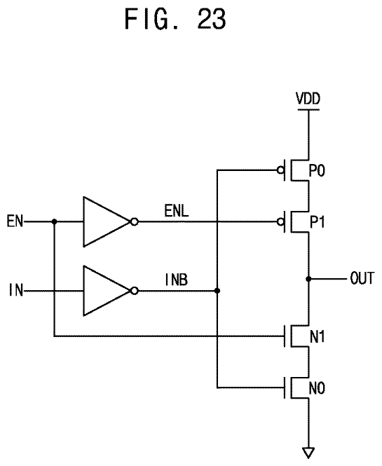

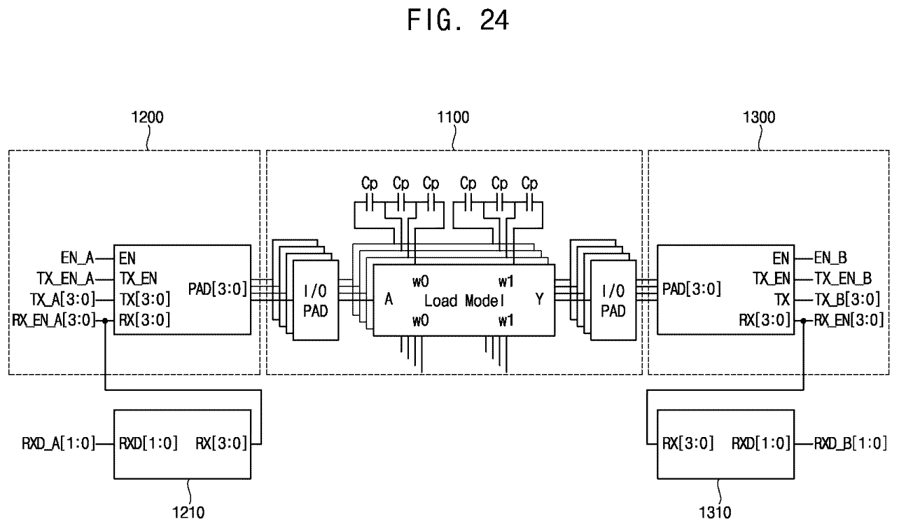

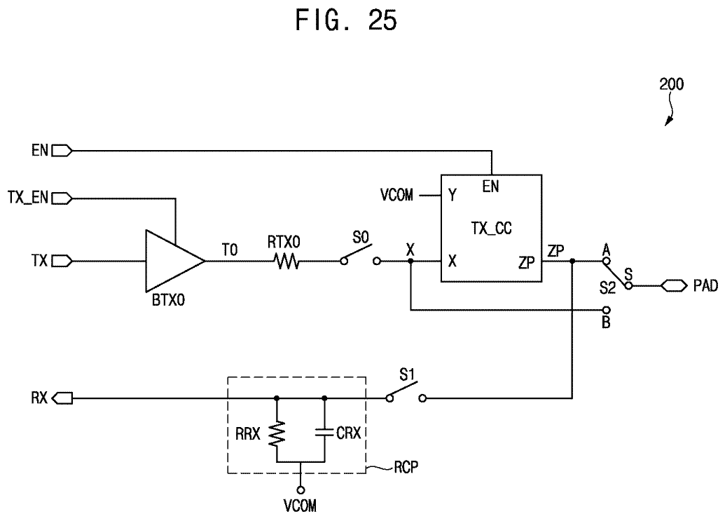

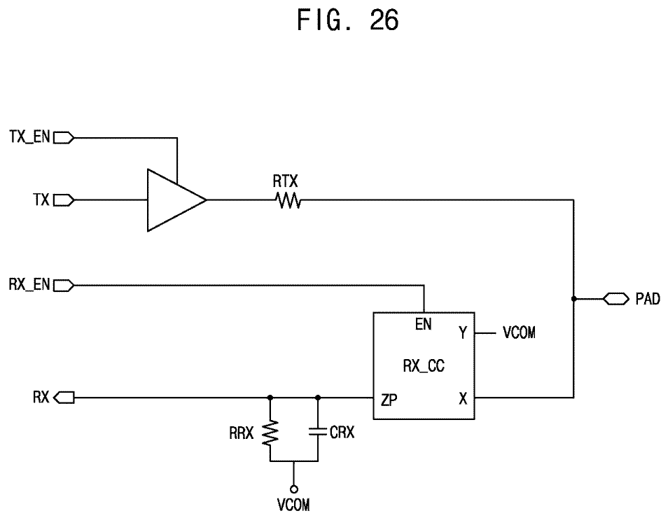

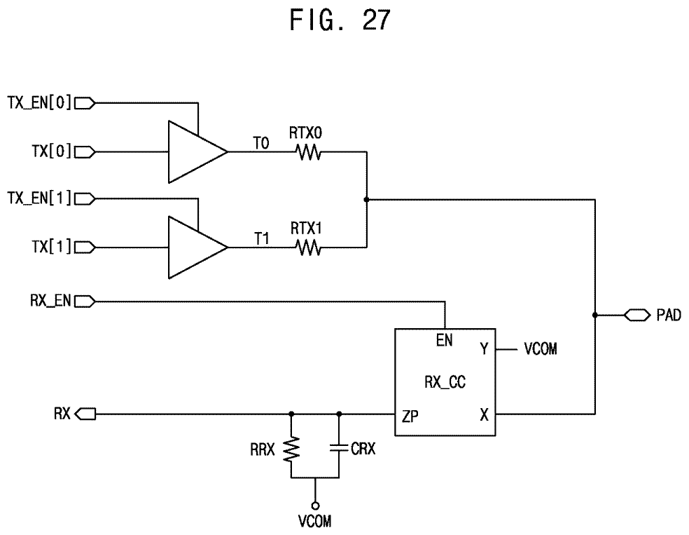

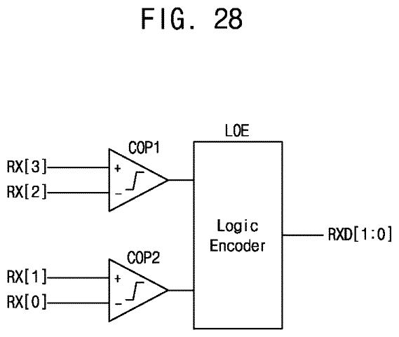

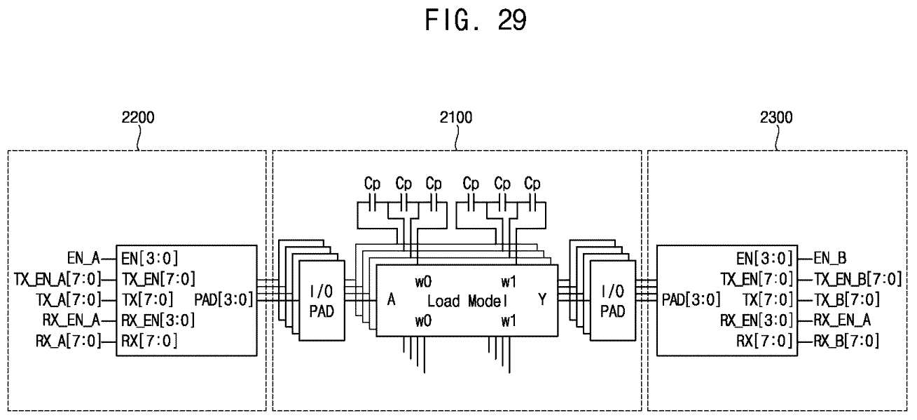

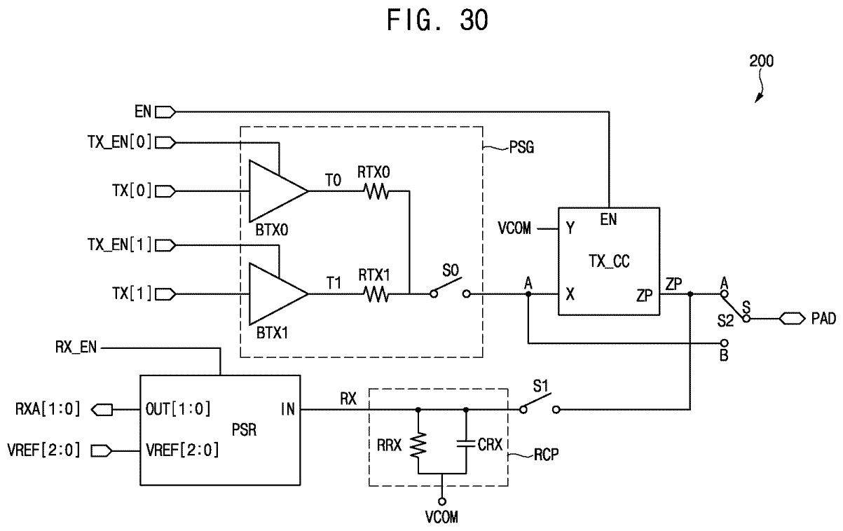

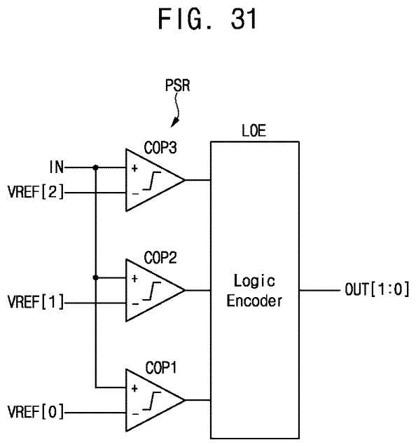

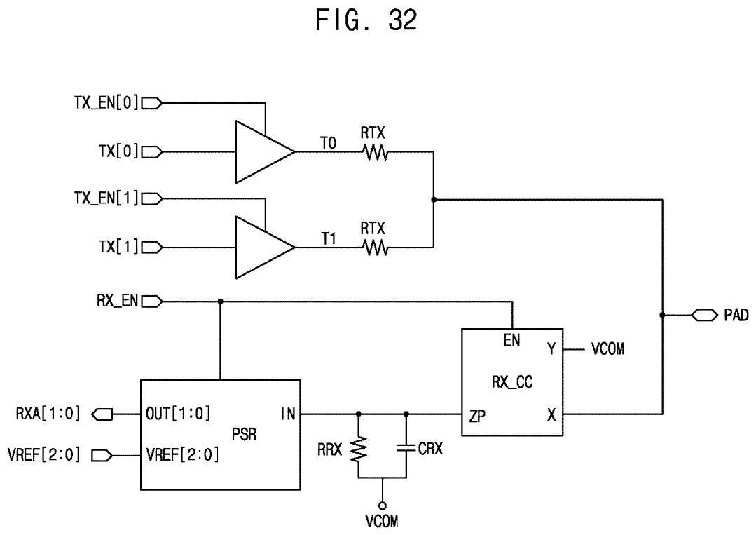

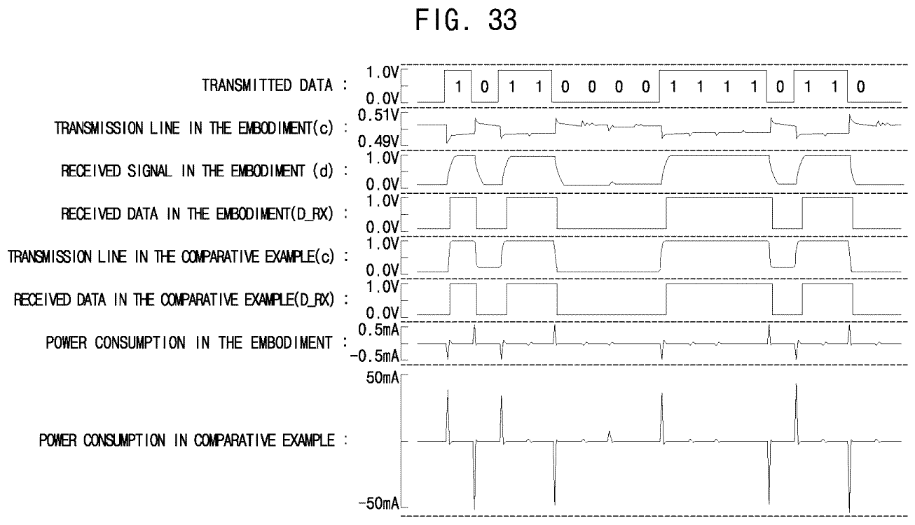

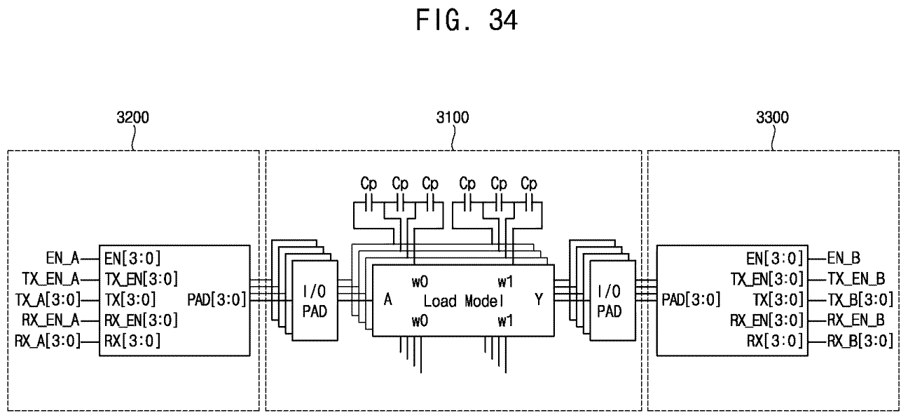

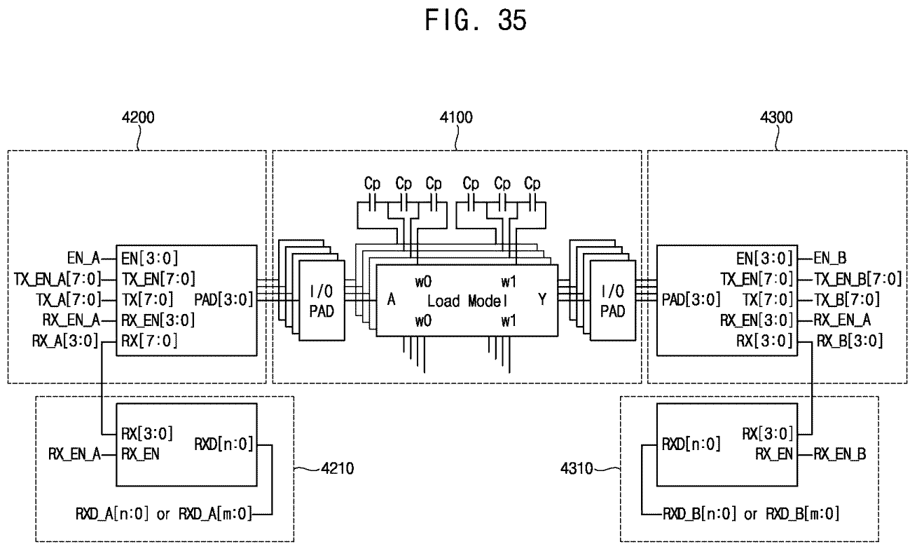

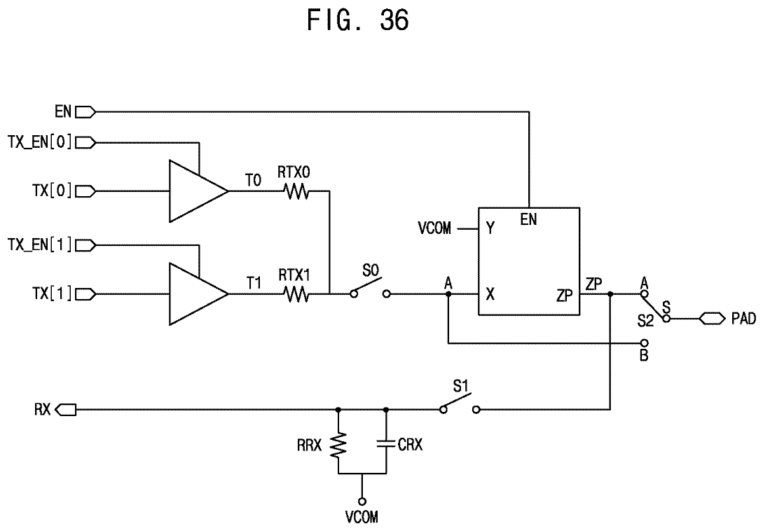

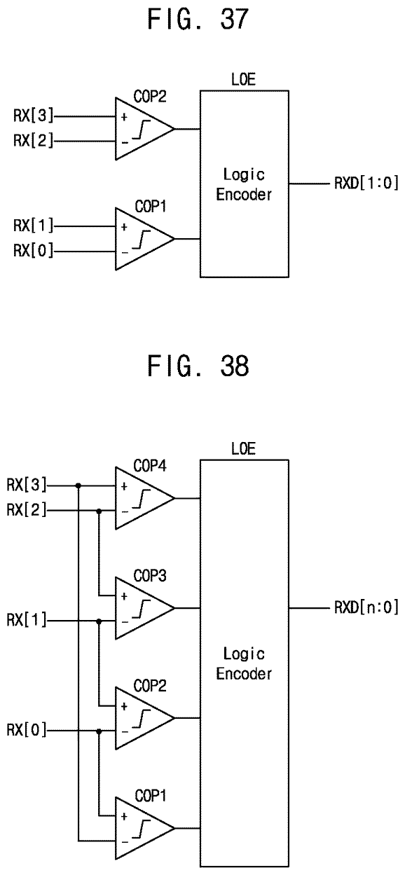

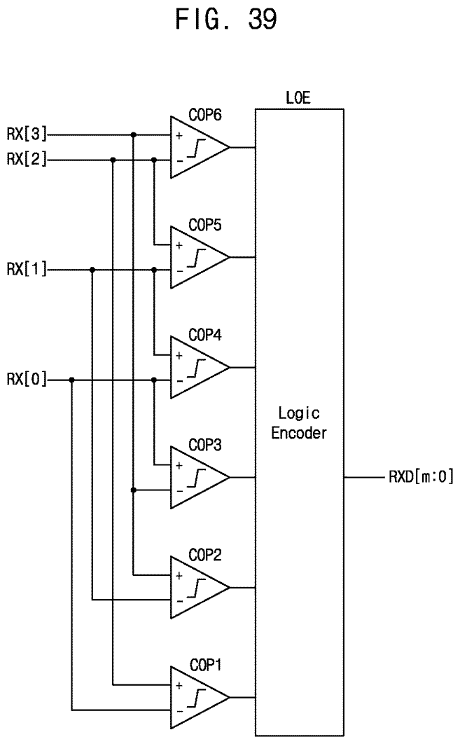

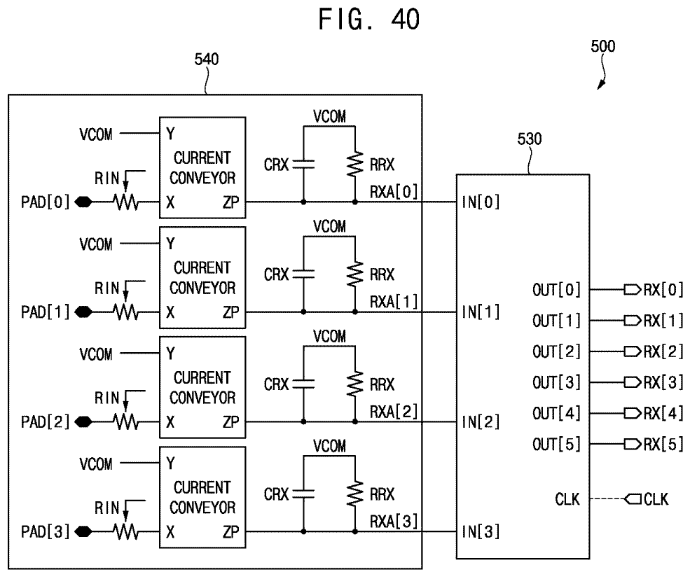

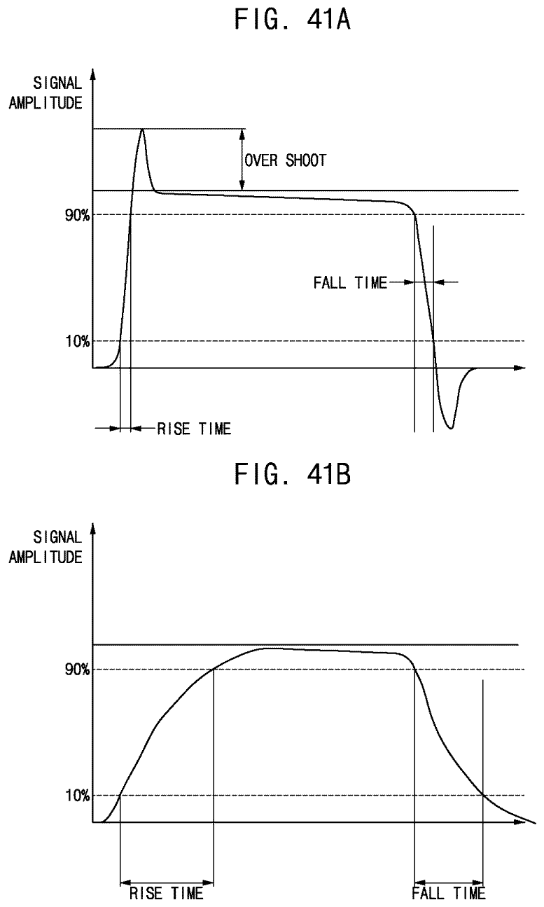

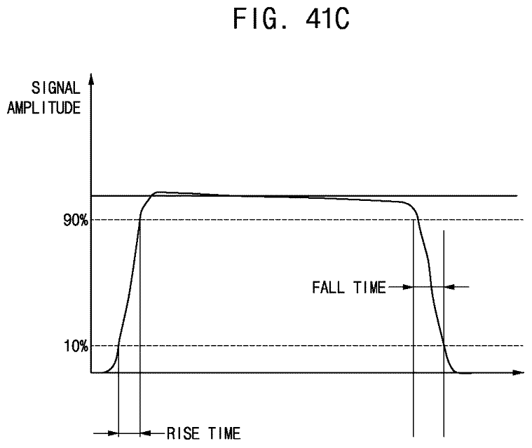

FIG. 23 is a circuit diagram for explaining another example of the TX buffer shown in FIG. 20. In particular, another example in which an enable pin EN is added to a TX buffer BTX is illustrated.

Referring to FIG. 20 and FIG. 23, when the enable pin EN is in the “0” state, MOSFET P1 is turned-off and MOSFET N1 is turned-off, thereby blocking the output of the TX buffer BTX.

When the enable pin EN is in the “1” state, both the MOSFET P1 and the MOSFET N1 are turned-on, and the output of the OUT terminal is controlled in the same phase according to the signal of the data input IN. Therefore, the TX buffer BTX shown in FIG. 23 is simple to control.

Referring again to FIG. 20, the TX resistor RTX determines a signal current value to be transmitted from the first communication module 200 which is a transmitting side to the second communication module 300 which is a receiving side. When the output of the TX buffer BTX is a first power voltage VDD (i.e., logic “1”), and the value of the common mode voltage VCOM of the TX current conveyor TX_CC is ½ VDD, the signal current value generated by the TX resistor RTX is as shown in Equation 4 below.

$${i}_{0} = \frac{( VDD - \frac{1}{2} VDD )}{RTX} \qquad [ Equation 4 ]$$

In this case, when the first power voltage VDD is set to 1.0V and the resistance value of the TX resistor RTX is set to 5KΩ, the common mode voltage VCOM is 0.5V, and the value of the signal current generated from the TX resistor RTX is +0.1 mA. Here, a forward current of 0.1 mA flows from the first power voltage VDD to the line c, which is the X-port of the RX current conveyor RX_CC.

In the same environment as above, when the output of the TX buffer BTX is 0V (i.e., logic “0”), the equation of the current generated by the TX resistor RTX is shown in the following Equation (5).

$${i}_{0} = \frac{( 0 - \frac{1}{2} VDD )}{RTX} \qquad [ Equation 5 ]$$

The value of the current becomes about −0.1 mA, so that a reverse current of about 0.1 mA flows from a signal line b, which is the X-port of the RX current conveyor RX_CC, to GND of the TX buffer BTX.

As described above, when both the TX buffer BTX and the TX resistor RTX are set to one, two current signal levels may be generated.

In the aforementioned method, when the TX buffer BTX and the TX resistor RTX are each set to two, four current signal levels may be generated. That is, when the EN signals of the TX buffer BTX are controlled respectively, four transmission signals, such as 11, 10, 01, and 00, may be input as binary values. Currents used in four communications, such as +0.3 mA, +0.1 mA, −0.1 mA, and −0.3 mA, may be generated for each of the four transmission signals. Therefore, a signal transmission capacity per unit transmission may be increased.

The TX current conveyor TX_CC of the first communication module 200 and the RX current conveyor RX_CC of the second communication module 300 include an X-port, which is a low-impedance port responsible for inputting and outputting current, a ZP-port that mirrors and outputs the current of the X-port, and a Y-port that is responsible for voltage input, respectively.

When the transmission signal D_TX is “1” (High), the current i0 is input to the signal line b, which is the X-port of the TX current conveyor TX_CC, through the TX resistance RTX from the output a of the TX buffer BTX based on the first power voltage VDD. At this time, the X-port of the TX current conveyor TX_CC connected to the signal line b generates a current i1 that has the same current value as the current i0 in the GND direction but has the opposite sign to maintain the same voltage level as the common mode voltage VCOM input to the Y-port.

At the same time, the current i1 is mirrored to generate the current i2 in the data transmission line c connected to the ZP-port. The current i2 is a communication signal current output to the data transmission line c and is a current flowing from the ZP-port (i.e., the data transmission line c) toward the GND. The current i2 generally has a ratio relationship of the current i1 to 1:1, but the magnification thereof may be set to be less than or greater than 1 as necessary.

The current i2 is connected to the X-port, which is the low impedance port of the RX current conveyor RX_CC, through the data transmission line c. In order to maintain the same voltage as the common mode voltage VCOM connected to the Y-port, the X-port of the RX current conveyor RX_CC generates a current i3 that is the same as the current i2 from the first power voltage VDD to the data transmission line c, but has opposite signs, and at the same time outputs the current i4 to the ZP-port of the RX current conveyor RX_CC.

At this time, the data transmission line c theoretically performs a function of maintaining the common mode voltage VCOM level regardless of the magnitude and sign of the communication current i2 (i.e., when transmitting the signal of logic “0” or when transmitting the signal of logic “1”). Therefore, when transmitting the data signal according to the present invention, there is no voltage change of the data transmission line c, or only a very small ripple voltage change of several mV is observed according to a signal change faster than the response speed of the TX current conveyor TX_CC and the RX current conveyor RX_CC.

In the absence of a negligible voltage change or change itself observed on the data transmission line c, the current consumed by the parasitic capacitance CIO of the data transmission line may be minimized or eliminated. This is in comparison to conventional technology that has transmitted data with large voltage signals, such as about 0.3V to about 1.2V. The reduction in power consumption of the data transmission line enables signal transmission at a higher speed with less energy.

Furthermore, given the negligible change in the voltage of the data transmission line c during communication operations, the emission of superfluous electromagnetic interference (EMI) noise is reduced. Additionally, when multiple data transmission lines are implemented in parallel, the quality of communication signals may be enhanced by minimizing signal interference due to cross-coupling capacitance between data transmission lines.

Due to this effect, signals may be transmitted with reduced power consumption on a lower quality data transmission line at a higher speed. This results in a reduction in the manufacturing cost of a high-speed parallel signal transmission system, a decrease in the amount of heating, and an improvement in the reliability and lifetime of the system.

The current i4 output from the ZP-port of the RX current conveyor RX_CC is restored to the signal of the received voltage through the RX resistor RRX connected in series with the common mode voltage VCOM through the signal line d.

The restored reception voltage may be expressed by an equation such as (VCOM+i4*RRX).

As an example of the transmitting side above, when the transmission currents are about +0.1 mA and about-0.1 mA, the TX current conveyor TX_CC and the RX current conveyor RX_CC mirror the current 1:1 and the RX resistor RRX is set to about 5KΩ equal to the TX resistor RTX, the common mode voltage VCOM becomes about 0.5V, and the current i4 becomes about +0.1 mA and about −0.1 mA, respectively. Accordingly, it may be confirmed that the reception voltage becomes 1V and 0V by the above equation, respectively, and the transmission signal is accurately transmitted to the reception signal.

Although the resistance value of the RX resistor RRX preferably has a ratio of 1:1 to the resistance value of the TX resistor RTX for generating a transmission voltage, the resistance value may be set to a value less than or greater than 1 if necessary depending on the conditions of the data transmission line and the transmission speed. However, it is preferable that the range of the resistance value of the RX resistor RRX should be determined in a range in which the value of the (VCOM+i4*RRX) is less than 0 or not greater than 1. An RX capacitor CRX connected in parallel with the RX resistor RRX is a capacitance element having a very small value and is not an essential component. If necessary, the capacitance of the RX capacitor CRX may be set so that the RX resistor RRX and the RC time constant of the RX capacitor CRX match the transmission speed of the signal to be transmitted, and may perform the role of a low pass filter to improve the SNR (signal-to-noise ratio) of the received signal.

When the voltage generated on the data transmission line c exceeds the threshold voltage on the input side of the RX buffer (i.e., when the logic is “1”), or is insufficient (i.e., when the logic is “0”), the output current of the corresponding signal is amplified and outputted as a logic value. Typically, a buffer with two inverters connected is used, but an inverter with a Schmitt-trigger function may be used as a pre-inverter to increase the SNR. In addition, when the voltage fluctuation rate of the data transmission line c is designed not to change significantly near the logic threshold voltage, a comparator circuit or AMP circuit based on the common mode voltage VCOM is applied.

In addition, when the operating voltage of the transmission/reception system and the logic core are different, a voltage converter (i.e., a voltage level shifter) should be used.

FIG. 24 is a block diagram for explaining a data communication system according to an exemplary embodiment of the present invention. FIG. 25 is a circuit diagram for explaining the first communication module shown in FIG. 24.

Referring to FIG. 24 and FIG. 25, a data communication system according to another embodiment of the present invention includes a data transmission line unit 1100, a first communication module unit 1200 connected to one end of the data transmission line unit 1100, a first differential decoder 1210, a second communication module unit 1300 connected to another end of the data transmission line unit 1100, and a second differential decoder 1310.

The data transmission line unit 1100 is configured to correspond to four data transmission lines arranged in parallel. Coupling capacitors between data transmission lines are all expressed as Cp values. However, each of the Cp values generally has a different value when an actual data transmission line is implemented, and the value has a relatively smaller value than the Cs values. In the present specification, values of the corresponding coupling capacitance are collectively referred to as Cp for convenience of description.

It is obvious that the basic data communication device with the four data transmission lines 1100 may be modularized again in parallel, and applied to an extended data communication device responsible for, for example, 256, 512 and 1024 communication lines.

The first communication module unit 1200 is defined by four first communication modules 200 arranged in parallel, and the second communication module unit 1300 is defined by four second communication modules 300 arranged in parallel.

The first communication module 200 includes a TX buffer BTX0, a TX resistor RTX0, a TX switch S0, a TX current conveyor TX_CC, a mode switching switch S2, an RX switch S1, and an RC parallel circuit RCP, and converts the input voltage signal into current and provides it to the transmission line 100.

The TX buffer BTX0, the TX resistor RTX0, the TX switch S0, the TX current conveyor TX_CC, and the mode switching switch S2 are connected in series with the TX current conveyor TX_CC.

The TX current conveyor TX_CC includes an EN-port to which an EN signal is input, a Y-port to which a common mode voltage VCOM is input, an X-port connected to the TX switch S0, and a ZP-port connected to the mode switching switch S2. In the present embodiment, the common mode voltage VCOM may be equal to ½ of the first power voltage VDD.

The mode switching switch S2 has a first terminal A, a second terminal B and a third terminal S. In this case, when the first terminal A and the third terminal S are connected, the ZP-port of the TX current conveyor TX_CC and the I/O pad are connected. Also, when the second terminal B and the third terminal S are connected, the ZP-port of the TX current conveyor TX_CC and the X-port of the TX current conveyor TX_CC are connected.

The RX switch S1 is connected between the ZP-port of the TX current conveyor TX_CC and the RC parallel circuit RCP. The RC parallel circuit RCP has a resistor and a capacitor connected in parallel so that one end thereof is connected to the RX switch S1, and the other end thereof is connected to the common mode voltage VCOM. Although the RC parallel circuit RCP is shown in the present embodiment, the resistor element may be disposed alone.

Only two signals are transmitted to four data transmission lines. At this time, a difference value between the first data transmission line and the second data transmission line and a difference value between the third data transmission line and the fourth data transmission line are signals to be transmitted.

FIG. 26 is a circuit diagram illustrating another example of the first communication module shown in FIG. 24.

Referring to FIG. 26, the switches, i.e., the TX switch S0, the RX switch S1 and the mode switching switch S2 are removed, and the current conveyor RX_CC is used only for signal reception in FIG. 25. Each buffer receiving the TX[0] and TX[1] signals includes one end to which resistors are connected and the other end directly connected to the PAD connected to the data transmission line. The high or low voltage output from each buffer is converted into a pull-up or pull-down current signal via a resistor RTX.

Although FIG. 26 shows that the TX resistor RTX is disposed at a rear end of the TX buffer BTX0, the TX resistor RTX may be omitted. That is, it may be implemented by removing the TX resistor RTX and controlling on-resistance values of the PMOS FET and the NMOS FET provided in the terminal driver or the output switch of the TX buffer BTX0.

In an example, when a PMOS FET and an NMOS FET of a termination driver are used, the circuit diagram illustrated in FIG. 22 may be used. That is, in FIG. 22, the Ron resistance value of the MOSFET P0 is set to be equal to the resistance value of the TX resistor RTX, and the Ron resistance value of the MOSFET N0 is set to be equal to the resistance value of the TX resistor RTX.

The Ron resistance value of the MOSFET may be defined as the following Equation (6).

$${R}_{DS ( on )} = \frac{L}{μ {C}_{ox} W ( {V}_{GS} - {V}_{TH} )} \qquad [ Equation 6 ]$$

Here, L is the channel length, μ is the carrier mobility, Cₒₓ is the oxide film capacitance, is the channel width, V_{GS} is the gate-source voltage, and V_{TH} is the threshold voltage.

In another example, when the PMOS FET and the NMOS FET provided in the output switch of the termination driver are used, the circuit diagram illustrated in FIG. 23 may be used. That is, in FIG. 23, for example, the MOSFET P0 and the MOSFET N0 are designed to have a very small on-resistance value like an idle switch, and the MOSFET P1 and the MOSFET N1 are designed to have the same Ron resistance value as the resistance value of the TX resistor RTX. In another example, the sum on-resistance value of the MOSFET P0 and the MOSFET P1 is set to be the same as the resistance value of the TX resistor RTX, and the sum on-resistance value of the MOSFET N0 and the MOSFET N1 is set to be the same as the resistance value of the TX resistor RTX.

FIG. 27 is a circuit diagram illustrating another example of the first communication module shown in FIG. 24.

Referring to FIG. 27, the switches, i.e., the TX switch S0, the RX switch S1 and the mode switching switch S2 are removed, and the current conveyor RX_CC is used only for signal reception in FIG. 25. Each buffer receiving the TX[0] and TX[1] signals includes one end to which resistors are connected and the other end directly connected to the PAD connected to the data transmission line. The high or low voltage output from each buffer is converted into a pull-up or pull-down current signal via a resistor RTX.

FIG. 28 is a block diagram for explaining the first differential decoder 1210 shown in FIG. 24.

Referring to FIG. 24 and FIG. 28, the first differential decoder 1210 includes a first comparator COP1, a second comparator COP1, and a logic encoder LOE.

The first comparator COP1 provides a first result value comparing the signal RX[0] and the signal RX[1] to the logic encoder LOE, and the second comparator COP1 provides a second result value comparing the signal RX[2] and the signal RX[3] to the logic encoder LOE. The logic encoder LOE represents the first and second result values as a 2-bit signal RXD[1:0].

When transmitting a 2-level signal, two bits of data are transmitted as differential signals to four data transmission lines. That is, in the case of encoding that transmits a signal, a 1-bit signal is input, and an in-phase signal is applied to one data transmission line and an in-phase signal is applied to the other data transmission line.

FIG. 29 is a block diagram for explaining a data communication system according to another exemplary embodiment of the present invention. In particular, a data communication system configured to correspond to four data communication devices is illustrated.

Referring to FIG. 29, a data communication system according to another embodiment of the present invention includes a data transmission line unit 2100, a first communication module unit 2200 connected to one end of the data transmission line unit 2100, and a second communication module unit 2300 connected to the other end of the data transmission line unit 2100.

The data transmission line unit 2100 is configured to correspond to four data transmission lines arranged in parallel. Coupling capacitors between data transmission lines are all expressed as Cp values. However, each of the Cp values generally has a different value when an actual data transmission line is implemented, and the value has a relatively smaller value than the Cs values. In the present specification, values of the corresponding coupling capacitance are collectively referred to as Cp for convenience of description.

It is obvious that the basic data communication device with the four data transmission lines 2100 may be modularized again in parallel, and applied to an extended data communication device responsible for, for example, 256, 512, and 1024 communication lines.

The first communication module unit 2200 is defined by four first communication modules 200 (shown in FIG. 4) arranged in parallel, and the second communication module unit 2300 is defined by four second communication modules 300 (shown in FIG. 4) arranged in parallel.

Here, the first enable signal EN_A, the first TX enable signal TX_EN_A, and the first RX enable signal RX_EN_A applied to the first communication module unit 2200 have a 1-bit value. Moreover, the first enable signal EN_A, the first TX enable signal TX_EN_A, and the first RX enable signal RX_EN_A are commonly applied to each of the four first communication modules 200 arranged in parallel. A first TX signal applied to the first communication module unit 2200 has an 8-bit value, and a first RX signal output from the first communication module unit 2200 has a 4-bit value. Moreover, the first TX signal is independently applied to each of the four first communication modules 200 arranged in parallel, and the first RX signal is independently output from each of the four first communication modules 200 arranged in parallel.

Moreover, the second enable signal EN_B, the second transmission enable signal TX_EN_B, and the second reception enable signal RX_EN_B which are applied to the second communication module unit 2300 have a 1-bit value. Moreover, the second enable signal EN_B, the second transmission enable signal TX_EN_B, and the second reception enable signal RX_EN_B are commonly applied to each of the four second communication modules 300 arranged in parallel. The second TX signal applied to the second communication module unit 2300 has an 8-bit value, and the second RX signal output from the second communication module unit 2300 has a 4-bit value. Moreover, the second TX signal is independently applied to each of the four second communication modules 300 arranged in parallel, and the second RX signal is independently output from each of the four second communication modules 300 arranged in parallel.

In the case of a data transmission line of N (where, N is a natural number), there exist two signal stages that may be transmitted: “0” and “1.” Therefore, the number of signals that may be transmitted at a time is 2\hat{ }N. For example, two data transmission lines may transmit four different values, and three data transmission lines may transmit eight different values.

On the other hand, as described in FIG. 24, when the signal steps to be transmitted to the N data transmission lines are divided by M (where, M is a natural number), the number of signals that may be transmitted at once is M\hat{ }N. That is, when there are N data transmission lines and each data transmission line has M signal steps, the number of values that may be transmitted increases to M\hat{ }N. For example, when the signal steps to be transmitted to three data transmission lines are divided into four, the number of signals that may be transmitted at once is 64. Moreover, when the signal steps to be transmitted to four data transmission lines are divided into four, the number of signals that may be transmitted at once is 256.

FIG. 30 is a circuit diagram for explaining a PAM4 signal (a four-level pulse amplitude-modulated signal) generator and a PAM4 signal restorer provided in the first communication module shown in FIG. 29. FIG. 31 is a block diagram for explaining a PAM4 signal restorer shown in FIG. 30.

Referring to FIG. 29, FIG. 30, and FIG. 31, the first communication module 200 includes a PAM4 signal generator PSG, a TX current conveyor TX_CC, a mode switching switch S2, an RX switch S1, an RC parallel circuit RCP, and a PAM4 signal restorer PSR. The first communication module 200 converts the input voltage signal into current, and provides the converted current to the data transmission line 100 of the data transmission line unit 2100.

In the present embodiment, the four first communication modules 200 form the first communication module unit 2200 to encode and decode PAM4 per transmission line. That is, two bits of the transmission signal are converted into a PAM4 signal having four signal levels through one communication module. Four communication modules are batched and transmit signals to four transmission lines. Receivers that classify signals of 2 bits per transmission line are represented by four bundles. This is an example of transmitting and receiving PAM4 signals in a single-ended manner per transmission line. In the above example, since there are four transmission lines and each transmission line can transmit 2 bits (i.e., 4 levels, PAM4), the number of data that can be transmitted/received by the four transmission lines becomes 256 (i.e., 2\hat{ }8).

The PAM4 signal generator PSG includes a first TX buffer BTX0, a first TX resistor RTX0, a second TX buffer BTX1, a second TX resistor RTX1, and a TX switch S0. Here, PAM4 is a modulation scheme in which two bits of data are transmitted in one symbol using four different amplitudes during data transmission, and is used for efficient signal transmission, especially in high-speed data communication. Since PAM4 is capable of transmitting more data than a binary number at once, more data may be transmitted in the same bandwidth.

The first TX buffer BTX0 and the first TX resistor RTX0 to which the TX_EN[0] signal and the TX[0] signal are applied are connected in series to one end of the TX switch S0, and the second TX buffer BTX1 and the second TX resistor RTX1 to which the TX_EN[1] signal and the TX[1] signal are applied are connected in series to one end of the TX switch S0.

The TX switch S0 is commonly connected to the first TX resistor RTX0 and the second TX resistor RTX1 through one end, and is commonly connected to the X-port and mode switching switch S2 of the TX current conveyor TX_CC through the other end.

The TX current conveyor TX_CC includes an EN-port to which an EN signal is input, a Y-port to which a common mode voltage VCOM is input, an X-port connected to the TX switch S0, and a ZP-port connected to the mode change switch S2.

The mode switching switch S2 has a first terminal A, a second terminal B and a third terminal S. In this case, when the first terminal A and the third terminal S are connected, the ZP-port of the TX current conveyor TX_CC and the I/O pad are connected. Also, when the second terminal B and the third terminal S are connected, the ZP-port of the TX current conveyor TX_CC and the X-port of the TX current conveyor TX_CC are connected.

The RX switch S1 is connected between the ZP-port of the TX current conveyor TX_CC and the RC parallel circuit RCP. The RC parallel circuit RCP includes a resistor and a capacitor connected in parallel, one end is connected to the RX switch S1 and the RX buffer BRX, and the other end is connected to the common mode voltage VCOM. The RX buffer BRX is connected to the RC parallel circuit RCP to output an RX signal.

In the present embodiment, there are four types of signal levels received from the data transmission line 100. That is, the “0” or “1” signal passing through the first TX buffer BTX0 and the first TX resistor RTX0 is applied to the TX current conveyor TX_CC, and the “0” or “1” signal passing through the second TX buffer BTX1 and the second TX resistor RTX1 is applied to the TX current conveyor TX_CC.

The PAM4 signal restorer PSR includes a first comparator COP1, a second comparator COP1, a third comparator COP1, and a logic encoder LOE to restore an RX signal passing through the RC parallel circuit RCP.

Specifically, the first comparator COP1 provides a first result value comparing an RX signal IN with a first reference voltage VREF[0] to the logic encoder LOE, the second comparator COP1 provides a second result value comparing an RX signal IN with a second reference voltage VREF[1] to the logic encoder LOE, and the third comparator COP1 provides a third result value comparing an RX signal IN with a third reference voltage VREF[2] to the logic encoder LOE. In this case, the first reference voltage VREF[0], the second reference voltage VREF[1], and the third reference voltage VREF[2] are used as reference voltages for comparing input levels of each RX signal IN.

The logic encoder LOE outputs the first to third result values as 2-bit RXA[1:0].

In the present embodiment, when the first and second TX resistors RTX0 and RTX1 are used, respectively, the ZP-port XZ output of the TX current conveyor TX_CC may be set to a value of −3, −1, +1, +3 as a current of a relative size. Moreover, when the first and second TX resistors RTX0 and RTX1 have different values, a weighted current value according to the value of the corresponding resistance may be changed to generate transmission current values of various levels.

When a transmission signal is encoded into 2 bits, an enable pin signal TX_EN is formed of 2 bits, and a data pin TX is formed of 2 bits. TX[1:0] which is a transmission signal is encoded into four values, the encoded value is converted into a current value through the resistors of the first TX resistor RTX0 and the second TX resistor RTX1, and the converted current value may be output to the data transmission line 100.

When the first communication module 200 operates in the reception mode, in order to classify the four reception values without using the RX buffer BRX described in FIG. 14, a corresponding level may be additionally decoded by using a comparator based on a reference value.

Alternatively, when the data communication device uses multiple data transmission lines 100, encoded signals may be transmitted between each data transmission line 100, and data may be decoded and restored using the difference between the received signals.

In FIG. 30, two TX buffers and two resistors are configured in the first communication module 200 to express four relative magnitude current values. In a similar manner, when three or more TX buffers and three or more resistors are configured in the first communication module 200, more relative magnitude current values may be expressed, but the description thereof is omitted herein.

FIG. 32 is a circuit diagram of another example for explaining a PAM4 signal generator and a PAM4 signal restorer provided in the first communication module shown in FIG. 24.

Referring to FIG. 32, switches, that is, the TX switch S0, the RX switch S1, and the mode switching switch S2 are removed in FIG. 30, and the current conveyor RX_CC is used only for signal reception. Resistors are connected to one end of each buffer receiving the TX[0] and TX[1] signals, and the other end is directly connected to the PAD connected to the data transmission line. High or low voltage outputs of each buffer are converted into pull-up or pull-down current signals through the resistor RTX, respectively.

FIG. 33 is a waveform diagram showing a simulation result of each of Examples and Comparative Examples transmitting a data pattern to one data transmission line. In particular, a simulation result of transmitting 16 data patterns for one data transmission line implemented by the technology of the present invention illustrated in FIG. 20 and the technology of the comparative example illustrated in FIG. 3 is illustrated.

Referring to FIG. 33, the comparative example and the embodiment were simulated and measured under the same conditions. That is, the transmission speed is set to 1 GHZ, the CIO value of the data transmission line is the same, and the first power voltage VDD is set to about 1.0 V.

For the peak-to-peak value of the voltage shown on the data transmission line c when transmitting the same transmission data, the embodiment is measured to be about 7 mV, while the comparative example is measured to be about 849 mV. Thus, it can be seen that the embodiment has a smaller voltage amplitude measured on the data transmission line of about 1/120 or less than the comparative example.

Furthermore, for the RMS current value consumed by the load CIO of the data transmission line under the same conditions, the embodiment is simulated to consume about 43.9 μA, while the comparative example is simulated to consume about 4.97 mA. Thus, it can be seen that the embodiment consumes less current on the data transmission line than the comparative example by about 1/113 or less.

In general, when the amount of change along the data transmission line (i.e., the amount of voltage change in the signal, the amount of charge energy in the load) is large and the transmission speed is high, it is necessary to limit the balance of the DC level to improve the quality of the signal appearing on the data transmission line.

When the same data value (e.g., “0” or “1”) is transmitted successively, the transmitted data will deviate from the ideal high and low band frequency transfer characteristics (impedance) of the data transmission line. This deviation can cause bit signal degradation due to a delay phenomenon, where the signal of the next conversion value does not respond quickly, or an imbalance in the transient response.

Therefore, in the prior art, the value of the transmitted data itself is not converted into the meaning of the bits (i.e, NRZI method), but rather, in order to balance the DC level, as in coding conversion standards such as 3B4B, 4B5B, 5B6B, 8B10B, 64B/66B, 128B/130B, etc., the data to be transmitted is encoded and transmitted in the form of data longer than the length of the transmitted data, with additional overhead bits included to statistically balance the “0” and “1” (i.e. to balance the DC levels).

For example, 4B5B represents the conversion of 4-bit data into 5-bit data, which encodes 4 bits of information into 5 bits for transmission. The 4B5B code is one of the line codes used in data communications that can reduce bit errors and increase the reliability of the signal.

The feature of 4B5B is that 4 bits are pre-block-coded into 5 bits so that a “0” or “1” is not transmitted continuously for a long time. In this case, there must be at least one transition within the 5-bit block code, and the data is configured so that three or more “0” are not continuous, so that there is an overall balance of “0” and “1”.

An example of the 4B5B code may be represented as shown in Table 1 below.

TABLE 1

| | Data bit | Code bit | |
|---|---|---|---|
| Name | (4 bits) | (5 bits) | NRZI |
| 0 | 0000 | 11110 | [symbol] |
| 1 | 0001 | 01001 | [symbol] |
| 2 | 0010 | 10100 | [symbol] |
| 3 | 0011 | 10101 | [symbol] |
| 4 | 0100 | 01010 | [symbol] |
| 5 | 0101 | 01011 | [symbol] |
| 6 | 0110 | 01110 | [symbol] |
| 7 | 0111 | 01111 | [symbol] |
| 8 | 1000 | 10010 | [symbol] |
| 9 | 1001 | 10011 | [symbol] |
| A | 1010 | 10110 | [symbol] |
| B | 1011 | 10111 | [symbol] |
| C | 1100 | 11010 | [symbol] |
| D | 1101 | 11011 | [symbol] |
| E | 1110 | 11100 | [symbol] |
| F | 1111 | 11101 | [symbol] |

Referring to Table 1, the data bit “0000” is encoded as the code bit “11110,” which has at least one transition and does not have three consecutive “0”s. Similarly, the data bit “0001” is encoded as the code bit “01001,” which also has at least one transition and does not have three consecutive “0”s. In this way, the conventional encoding method can improve the quality of the communication signal, but a disadvantage is that the amount of data that can be transmitted at the same speed (data rate) is reduced due to the overhead bits that are additionally inserted.

However, as can be seen from the comparison of the waveforms that appear during signal transmission (i.e., the voltage waveform of the transmission line c of the present invention and the voltage waveform of the transmission line c in the comparative example), the voltage fluctuation and the energy required for the charging/discharging of the data transmission line according to the present invention are about 1/100 or less compared to the comparative example. Therefore, the present invention can significantly relax the limitations on the balance of the DC level. Moreover, with this relaxation, the quality of the signal can be sufficiently guaranteed even with data transmission that does not use separate encoding for the balance of the DC level.

FIG. 34 is a configuration diagram for explaining a data communication system according to another exemplary embodiment of the present invention. In particular, a data communication system configured to correspond to four data communication devices is illustrated.

Referring to FIG. 34, a data communication system according to another embodiment of the present invention includes a data transmission line unit 3100, a first communication module unit 3200 connected to one end of the data transmission line unit 3100, and a second communication module unit 3300 connected to the other end of the data transmission line unit 3100.

The data transmission line unit 3100 is configured to correspond to four data transmission lines arranged in parallel. Coupling capacitors between data transmission lines are all expressed as Cp values. However, each of the Cp values generally has a different value when an actual data transmission line is implemented, and the value has a relatively smaller value than the Cs values. In the present specification, values of the corresponding coupling capacitance are collectively referred to as Cp for convenience of description.

It is obvious that the basic data communication device with the four data transmission lines 3100 may be modularized again in parallel, and applied to an extended data communication device responsible for, for example, 256, 512 and 1024 communication lines.

The first communication module unit 3200 is defined by four first communication modules 200 (shown in FIG. 4 and FIG. 14) arranged in parallel, and the second communication module unit 3300 is defined by four second communication modules 300 (shown in FIG. 4) arranged in parallel.

Here, the first enable signal EN_A, the first TX enable signal TX_EN_A, and the first RX enable signal RX_EN_A applied to the first communication module unit 3200 have a 1-bit value. Moreover, the first enable signal EN_A, the first TX enable signal TX_EN_A, and the first RX enable signal RX_EN_A are commonly applied to each of the four first communication modules 200 arranged in parallel. A first TX signal applied to the first communication module unit 3200 and a first RX signal output from the first communication module unit 3200 have a 4-bit value. Moreover, the first TX signal is independently applied to each of the four first communication modules 200 arranged in parallel, and the first RX signal is independently output from each of the four first communication modules 200 arranged in parallel.

Moreover, the second enable signal EN_B, the second transmission enable signal TX_EN_B, and the second reception enable signal RX_EN_B which are applied to the second communication module unit 3300 have a 1-bit value. Moreover, the second enable signal EN_B, the second transmission enable signal TX_EN_B, and the second reception enable signal RX_EN_B are commonly applied to each of the four second communication modules 300 arranged in parallel. The second TX signal applied to the second communication module unit 3300 and the second RX signal output from the second communication module unit 3300 have a 4-bit value. Moreover, the second TX signal is independently applied to each of the four second communication modules 300 arranged in parallel, and the second RX signal is independently output from each of the four second communication modules 300 arranged in parallel.

In the case of a data transmission line of N (where, N is a natural number), there exist two signal stages that may be transmitted: “0” and “1.” Therefore, the number of signals that may be transmitted at a time is 2\hat{ }N. For example, two data transmission lines may transmit four different values, and three data transmission lines may transmit eight different values.

On the other hand, as described in FIG. 34, when the signal steps to be transmitted to the N data transmission lines are divided by M (where, M is a natural number), the number of signals that may be transmitted at once is MAN. That is, when there are N data transmission lines and each data transmission line has M signal steps, the number of values that may be transmitted increases to MAN. For example, when the signal steps to be transmitted to three data transmission lines are divided into four, the number of signals that may be transmitted at once is 64. Moreover, when the signal steps to be transmitted to four data transmission lines are divided into four, the number of signals that may be transmitted at once is 256.

In the configuration described in FIG. 34, in order to transmit/receive a differential signal from the first communication module unit 3200 to the second communication module unit 3300, an RX[3:0] pin of circuits shown in FIG. 37 which will be described later may be additionally connected to an RX_B[3:0] pin of the second communication module unit 3300 to obtain a result of RXD[1:0]. In this case, an encoding unit for encoding transmission data should be added to the first communication module unit 3200, and a decoding unit for decoding reception data should be added to the second communication module unit 3300. Similarly, a configuration for transmitting/receiving a differential signal from the second communication module unit 3300 to the first communication module unit 3200 is similar to the configuration described above.

FIG. 35 is a configuration diagram for explaining a data communication system according to another exemplary embodiment of the present invention. FIG. 36 is a circuit diagram for explaining the first communication module shown in FIG. 35.

Referring to FIG. 35 and FIG. 36, a data communication system according to another embodiment of the present invention includes a data transmission line unit 4100, a first communication module unit 4200 connected to one end of the data transmission line unit 4100, a first differential signal decoder 4210, a second communication module unit 4300 connected to the other end of the data transmission line unit 4100, and a second differential signal decoder 4310.

The data transmission line unit 4100 is configured to correspond to four data transmission lines arranged in parallel. Coupling capacitors between data transmission lines are all expressed as Cp values. However, each of the Cp values generally has a different value when an actual data transmission line is implemented, and the value has a relatively smaller value than the Cs values. In the present specification, values of the corresponding coupling capacitance are collectively referred to as Cp for convenience of description.

It is obvious that the basic data communication device with the four data transmission lines 4100 may be modularized again in parallel, and applied to an extended data communication device responsible for, for example, 256, 512 and 1024 communication lines.

The first communication module unit 4200 is defined by four first communication modules 200 arranged in parallel, and the second communication module unit 4300 is defined by four second communication modules 300 arranged in parallel.

The first communication module 200 includes a first TX buffer BTX0, a first TX resistor RTX0, a second TX buffer BTX1, a second TX resistor RTX1, a TX switch S0, a TX current conveyor TX_CC, a mode switching switch S2, an RX switch S1, and an RC parallel circuit RCP, and converts the input voltage signal into current and provides the current to the data transmission line unit 4100. In the present embodiment, only two signals are transmitted to four data transmission lines. In this case, the difference value between a first data transmission line and a second data transmission line, and the difference value between a third data transmission line and a fourth data transmission line are signals to be transmitted. When transmitting one data value (i.e., 1 bit) through two data transmission lines, it is used for stable signal transmission using very important information such as clock information or a sufficiently large difference in a signal between two signals in a noisy system. In other words, although the transmission efficiency is low, it is used for stable signal transmission in a noise system.

The first TX buffer BTX0 and the first TX resistor RTX0 to which the TX_EN[0] signal and the TX[0] signal are applied are connected in series to one end of the TX switch S0, and the second TX buffer BTX1 and the second TX resistor RTX1 to which the TX_EN[1] signal and the TX[1] signal are applied are connected in series to one end of the TX switch S0.

The TX switch S0 is commonly connected to the first TX resistor RTX0 and the second TX resistor RTX1 through one end, and is commonly connected to the X-port and mode switching switch S2 of the TX current conveyor TX_CC through the other end.

The TX current conveyor TX_CC includes an EN-port to which an EN signal is input, a Y-port to which a common mode voltage VCOM is input, an X-port connected to the TX switch S0, and a ZP-port connected to the mode change switch S2.

The mode switching switch S2 has a first terminal A, a second terminal B and a third terminal S. In this case, when the first terminal A and the third terminal S are connected, the ZP-port of the TX current conveyor TX_CC and the I/O pad are connected. Also, when the second terminal B and the third terminal S are connected, the ZP-port of the TX current conveyor TX_CC and the X-port of the TX current conveyor TX_CC are connected.

The RX switch S1 is connected between the ZP-port of the TX current conveyor TX_CC and the RC parallel circuit RCP. The RC parallel circuit RCP has a resistor and a capacitor connected in parallel so that one end thereof is connected to the RX switch S1, and the other end thereof is connected to the common mode voltage VCOM. Although the RC parallel circuit RCP is shown in the present embodiment, the resistor element alone may be replaced by the RC parallel circuit RCP.

In FIG. 36, four relative magnitude current values are expressed by configuring two TX buffers and two resistors in the first communication module 200. In a similar manner, when three or more TX buffers and three or more resistors are configured in the first communication module 200, more relative magnitude current values may be expressed. However, this is omitted in the present specification.

FIG. 37 is a block diagram for explaining a first differential signal decoder shown in FIG. 35. Referring to FIG. 35 and FIG. 37, the first differential signal decoder 4210 includes a first comparator COP1, a second comparator COP1, and a logic encoder LOE.

The first comparator COP1 provides a first result value comparing the signal RX[0] and the signal RX[1] to the logic encoder LOE, and the second comparator COP1 provides a second result value comparing the signal RX[2] and the signal RX[3] to the logic encoder LOE. The logic encoder LOE represents the first and second result values as a 2-bit signal RXD[1:0].

When transmitting a 2-level signal, two bits of data are transmitted as differential signals to four data transmission lines. That is, in the case of encoding that transmits a signal, a 1-bit signal is input, and an in-phase signal is applied to one data transmission line and an in-phase signal is applied to the other data transmission line.

FIG. 38 is a diagram for explaining another example of a decoding unit added to the second communication module unit shown in FIG. 36.

Referring to FIG. 34, a decoding unit according to another example includes a first comparator COP1, a second comparator COP1, a third comparator COP3, a fourth comparator COP4, and a logic encoder LOE.

The first comparator COP1 provides a first result value comparing the signal RX[0] with the signal RX[3] to the logic encoder LOE, and the second comparator COP1 provides a second result value comparing the signal RX[0] with the signal RX[1] to the logic encoder LOE. In addition, the third comparator COP3 provides the third result value comparing the signal RX[1] with the signal RX[2] to the logic encoder LOE, and the fourth comparator COP4 provides the fourth result value comparing the signal RX[2] with the signal RX[3] to the logic encoder LOE. The logic encoder LOE represents the first to fourth result values as n-bit signal RXD[n:0].

In the present embodiment, a scheme used for signal transmission (PAM3 or higher) of at least 3-level may be used. In the present example, a 4-level signal transmission scheme (PAM4) is described as a reference.

Four transmission lines are used to transmit and receive data of specific bit values designated by the encoder and decoder as differential signals. Four comparators are used to compare the signals received from each of the four transmission lines.

The results of these comparators' values are used to select valid values that do not overlap, which are then transmitted and received. Encoding logic (used during transmission) and decoding logic (used during reception) are required.

Meanwhile, in the configuration described in FIG. 34, in order to transmit/receive a PAM4 signal from the first communication module unit 4200 to the second communication module unit 4300, the RX[3:0] pins of the second communication module unit 4300 shown in FIG. 38 and FIG. 39 need to be additionally connected to obtain results such as RXD[n:0] or RXD[m:0]. Here, an encoding unit must be added to the first communication module unit 4200 to encode the transmission data, and a decoding unit must be added to the second communication module unit 4300 to decode the received data. Similarly, the configuration for transmitting/receiving differential signals from the second communication module unit 4300 to the first communication module unit 4200 is also similar to the configuration described above.

FIG. 39 is a diagram for explaining another example of a decoding unit added to the second communication module unit shown in FIG. 36.

Referring to FIG. 39, a decoding unit according to another example includes a first comparator COP1, a second comparator COP1, a third comparator COP3, a fourth comparator COP4, a fifth comparator COP5, a sixth comparator COP6, and a logic encoder LOE.

The first comparator COP1 provides a first result value comparing the signal RX[0] with the signal RX[2] to the logic encoder LOE, and the second comparator COP1 provides a second result value comparing the signal RX[1] with the signal RX[3] to the logic encoder LOE. In addition, the third comparator COP3 provides the third result value comparing the signal RX[0] with the signal RX[3] to the logic encoder LOE, and the fourth comparator COP4 provides the fourth result value comparing the signal RX[0] with the signal RX[1] to the logic encoder LOE. In addition, the fifth comparator COP5 provides the fifth result value comparing the signal RX[1] with the signal RX[2] to the logic encoder LOE, and the sixth comparator COP6 provides the sixth result value comparing the signal RX[2] with the signal RX[3] to the logic encoder LOE. The logic encoder LOE represents the first to sixth result values as m-bit signal RXD[m:0].

In the present embodiment, a scheme used for signal transmission (PAM3 or higher) of at least 3-level may be used. In the present example, a 4-level signal transmission scheme (PAM4) is described as a reference.

Four transmission lines are used to transmit and receive data of specific bit values designated by the encoder and decoder as differential signals. Six comparators are used to compare the signals received from each of the four transmission lines. The results of these comparators' values are used to select valid values that do not overlap, which are then transmitted and received. Encoding logic (used during transmission) and decoding logic (used during reception) are required.

The decoding unit illustrated in FIG. 39 additionally includes a first comparator COP1 for comparing the signal RX[0] with the signal RX[2] compared with the decoding unit illustrated in FIG. 38, and a second comparator COP1 for comparing the signal RX[1] with the signal RX[3]. Accordingly, the case where the comparison values are duplicated among the values determined by the four comparators is further subdivided, and the number of cases of data that may be expressed by data encoding and data decoding may be increased.

FIG. 40 is a circuit diagram illustrating an example of a receiving unit provided in the data communication device of the present invention. In particular, a circuit diagram illustrating an example of the receiving unit RCV shown in FIG. 3.

Referring to FIG. 40, the receiving unit 500 includes a voltage generating part 540 that converts the current of the RX signal provided through the transmission line into a voltage, and a voltage comparator module 530 that differentially compares the RX signals converted into voltage by the voltage generating part 540.

The voltage generating part 540 includes a plurality of variable resistors RIN connected to the transmission line at one end, a plurality of current conveyor CC connected to the other end of the variable resistor RIN, and a plurality of RC parallel circuits placed between the current conveyor CC and the voltage comparator module 530.

The variable resistor RIN is placed between the pad and the X-port of the current conveyor.

Each of the current conveyor CC is connected to the four transmission lines of the link unit through a variable resistor RIN in a one-to-one manner.

Each of the RC parallel circuits includes a resistor RRX and a capacitor CRX having one end connected to the ZP-port of the current conveyor CC and the other end connected to the common mode voltage (or common ground voltage). The resistor RRX converts the current of the PAM4 signal provided through the ZP-port of the current conveyor CC into a voltage, and the capacitor CRX improves the signal quality by bypassing the high frequency component or adjusting the frequency response. The capacitor CRX may perform a high frequency noise removal and equalization function together with the resistor RRX.

Specifically, in order to generate the voltage value RXA[3:0] of the transmitted signal, the resistor RRX is disposed between the ZP-port of the current conveyor CC and the common mode voltage VCOM to convert the current, which is the transmitted signal, into a voltage. In addition, the capacitor CRX is disposed between the ZP-port of the current conveyor CC and the common mode voltage VCOM, and may operate as a manual filter for high-frequency noise removal or equalization in cooperation with the resistor RRX in the process of converting current into voltage.

Although FIG. 40 shows that the voltage generating part 520 includes a plurality of RC parallel circuits, the capacitor CRX connected between the PAD and the common mode voltage (or the common ground voltage) may be selectively used. That is, the capacitor CRX may be omitted from the voltage generating part 510.

The voltage comparator module 530 includes a comparator (or OPAMP) having six differential input terminals (Differential inputs) for RX signal classification from four RXA[3:0] outputs. When four transmission lines are named A, B, C, and D, and each transmission line is connected to PAD [0], PAD [1], PAD [2], and PAD [3] of the receiver, the voltage comparator module 530 compares the PAD signals of RX[0]=(A−B), RX[1]=(B−C), RX[2]=(C−D), RX[3]=(D−A), RX[4]=(A−C), and RX[5]=(B−D), respectively, and outputs the values of RX[0:5] as input values of the decoder circuit. Here, A denotes RXA[0], B denotes RXA[1], C denotes RXA[2], and D denotes RXA[3].

The CLK used in the voltage comparator module 530 may be selectively used depending on the type of the voltage comparator. The voltage comparator of the voltage comparator module 530 is a circuit that detects a difference between a differential signal, i.e., a positive input voltage and a negative input voltage and converts the difference into a digital signal (e.g., High (1) or Low (0)).

In this embodiment, the use of the variable resistor RIN, that is, the reason why the variable resistor for impedance matching is necessary for the X-port, will be described as follows.

In order to receive the current transmitted from the transmitting unit DRV (see FIG. 3), the current conveyor of the receiving unit RCV drives a current opposite to the current transmitted to the X-port. In this case, when the impedance of the transmission line coincides with the output impedance of the X-port, the received signal may guarantee the optimal rising time and polling time without overshooting or undershooting, thereby improving communication quality.

A transmission line is a PCB, a TSV, a wire, etc., and has various shapes, lengths, and configuration conditions. Thus, the impedance of the transmission line may be different. Therefore, it is necessary to match (or equalize the impedance) the output impedance of the X-port of the receiver, which is the receiver, with the impedance of the transmission line.

For such impedance matching, a variable resistor capable of changing and adjusting the resistance value is inserted between the PAD of the receiving unit RCV and the X-port of the current conveyor in this invention.

FIG. 41A, FIG. 41B, and FIG. 41C are graphs showing the signal amplitude according to the output impedance of the X-port of the receiving unit shown in FIG. 40. In particular, FIG. 41A is a graph showing waveforms when the output impedance of the X-port of the receiving unit RCV shown in FIG. 40 is a graph showing waveforms when the output impedance of the X-port of the receiving unit RCV shown in FIG. 40 is high, and FIG. 41C is a graph showing waveforms when the output impedance of the X-port of the receiving unit RCV shown in FIG. 40 is appropriate.

Referring to FIG. 41A, when the output impedance of the X-port is less than the impedance of the transmission line, waveforms of the overshoot and the undershoot interrupting the communication are generated. In this case, by increasing the resistance value of the variable resistor RIN and adjusting the output impedance of the X-port to match the impedance of the transmission line, a signal waveform used in stable communication as illustrated in FIG. 41C may be generated

Referring to FIG. 41B, when the output impedance of the X-port is greater than the impedance of the transmission line, there is no overshoot or undershoot, but the rising time and the polling time are large. In this case, by reducing the resistance value of the variable resistor RIN and adjusting the output impedance of the X-port to match the impedance of the transmission line, an optimal rising time and polling time as shown in FIG. 41C may be guaranteed, and thus a signal waveform used for stable communication may be generated.

As described above, according to the present invention, by converting a current signal-based communication technique, that is, a voltage level TX signal into a current level TX signal, output the current level TX signal to one side of the data transmission line, and converting the current level RX signal provided through the data transmission line into a voltage level RX signal, communication can be performed only with a current signal by minimizing the amplitude of the voltage signal transmission in the actual implementation to less than 0V or tens of mV.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A data communication device comprising:
a data transmission line;
a first communication module, which is connected to one side of the data transmission line and is configured to convert a TX signal of a voltage level provided by an external device into a TX signal of a current level, and output the converted TX signal to one side of the data transmission line, in order to communicate solely using current, free from interference between the capacitive load present on the data transmission line and the data transmission line; and
a second communication module, which is connected to the other side of the data transmission line and is configured to convert an RX signal of a current level, provided via the data transmission line, into an RX signal of a voltage level, in order to communicate solely using current, free from interference between the capacitive load present on the data transmission line and the data transmission line,
wherein the first communication module and the second communication module each include a mode switching switch that allows switching between a data transmission mode and a data receiving mode, or between a data receiving mode and a data transmission mode, controlled by a communication direction control signal, enabling bidirectional communication.

2. The data communication device of claim 1, wherein the data transmission line comprises at least one of a Through Silicon Via (TSV), a Through Glass Via (TGV), a Silicon Interposer, a Glass Interposer, and a PCB pattern.

3. The data communication device of claim 1, wherein each of the first communication module and the second communication module comprises a current conveyor comprising: an EN-port for receiving an EN signal, a Y-port for receiving a common-mode voltage, an X-port, and a ZP-port connected to a mode switching switch; and
wherein the current conveyor converts a voltage level TX signal into a current level TX signal and simultaneously mirrors the converted current level TX signal for output.

4. The data communication device of claim 3, wherein the mode switching switch comprises a first terminal connected to the ZP-port of the current conveyor, a second terminal connected to the X-port of the current conveyor, and a third terminal connected to the I/O pad of the data transmission line;
wherein the ZP-port of the current conveyor and the I/O pad are connected to each other, when the first terminal and the third terminal are connected to each other, and the X-port of the current conveyor and the I/O pad are connected to each other when the second terminal and the third terminal are connected to each other.

5. The data communication device of claim 3, wherein each of the first communication module and the second communication module further comprises:
a TX buffer receiving the voltage level TX signal;
a TX resistor connected to an output terminal of the TX buffer; and
a TX switch connected between the TX resistor and the X-port of the current conveyor;
wherein the current conveyor is connected to the mode switching switch through the ZP-port.

6. The data communication device of claim 5, wherein each of the first communication module and the second communication module further comprises:
a second switch connected to the ZP-port of the current conveyor; and
at least one of an RC parallel circuit and a resistive element having one end connected to the second switch and the other end connected to a common-mode voltage.

7. The data communication device of claim 6, when the at least one of the first communication module and the second communication module operates in a data receiving mode,
wherein the received current transmitted through the data transmission line is applied to the X-port of the current conveyor of the communication module operating in a data receiving mode,
the common-mode voltage is applied to the Y-port of the corresponding current conveyor,
the current mirrored from the received current based on the common-mode voltage is output through the ZP-port of the corresponding current conveyor, and
the mirrored current output through the ZP-port of the current conveyor is converted into a voltage by the at least one of the RC parallel circuit and the resistive element.

8. The data communication device of claim 6, wherein each of the first communication module and the second communication module further comprises an RX buffer connected to the RC parallel circuit or the resistive element.

9. The data communication device of claim 8, wherein the RX buffer comprises one of a Schmitt-trigger circuit, a logic buffer and a comparator circuit.

10. The data communication device of claim 1, wherein each of the first communication module and the second communication module comprises:
a transmission mode unit converting the voltage level TX signal into a current level signal and outputting the converted current level signal through the I/O pad to the data transmission line; and
a reception mode unit converting the current level signal input from the data transmission line connected through the I/O pad into a voltage level RX signal.

11. The data communication device of claim 10, wherein the transmission mode unit comprises:
a first buffer comprising a front-end inverter enabled by a TX_EN signal that inverts the TX signal, and a rear-end inverter connected to a rear end of the front-end inverter and enabled by the TX_EN signal to invert the signal inverted by the front-end inverter; and
a voltage-to-current converter connected to the output terminal of the first buffer and the I/O pad to comprise a pull-up current source, a pull-down current source, a pull-up switch and a pull-down switch.

12. The data communication device of claim 10, wherein the reception mode unit comprises:
a buffer that is enabled by a TX_EN signal and buffers the TX signal.

13. The data communication device of claim 12, wherein the reception mode unit further comprises:
a voltage-to-current converter connected to the rear end of the buffer and providing a pull-up current source and a pull-down current source.

14. The data communication device of claim 10, wherein the reception mode unit comprises a resistor.

15. The data communication device of claim 10, wherein the reception mode unit comprises:
an RX current conveyor connected to the I/O pad;
at least one of an RC parallel circuit and resistive element receiving and charging the received current output through the ZP-port of the RX current conveyor to form a received voltage; and
an RX buffer outputting the received voltage formed by the at least one of the RC parallel circuit ant the resistive element through the RX terminal to an external device.

16. The data communication device of claim 3, wherein each of the first communication module and the second communication module comprises:
a first TX buffer receiving a first TX signal of a voltage level;
a second TX buffer receiving a second TX signal of a voltage level;
a first TX resistor connected to an output terminal of the first TX buffer;
a second TX resistor connected to an output terminal of the second TX buffer; and
a TX switch having one end connected to the first TX resistor and the second TX resistor, and the other end connected to the X-port of the current conveyor.

17. The data communication device of claim 3, wherein each of the first communication module and the second communication module comprises a PAM4 signal generator,
wherein the PAM4 signal generator comprises:
a first TX buffer to which the first TX signal of the voltage level is input;
a second TX buffer to which a second TX signal of the voltage level is input;
a first TX resistor with one end connected to the output terminal of the first TX buffer and the other end connected to the data transmission line; and
a second TX resistor with one end connected to the output terminal of the second TX buffer and the other end connected to the data transmission line.

18. The data communication device of claim 13, wherein each of the first communication module and the second communication module comprises:
an RX switch connected to the ZP-port of the current conveyor and the mode switching switch;
at least one of an RC parallel circuit and a resistive element connected to the RX switch; and
a PAM4 signal restorer restoring an RX signal passing through the RC parallel circuit or the resistive element.

19. The data communication device of claim 18, wherein each of the first communication module and the second communication module is switchable between a data transmission mode and a data receiving mode,
wherein the TX switch is turned-on and the RX switch is turned-off in a data transmission mode, and the TX switch is turned-off and the RX switch is turned-on in a data receiving mode.

20. The data communication device of claim 19, wherein each of the first TX buffer and the second TX buffer output the transmission signal to the data transmission line in a data transmission mode, and the RX buffer restores the received signal in a data receiving mode.

21. The data communication device of claim 18, wherein the PAM4 signal restorer comprises:
a first comparator comparing the RX signal with a first reference voltage to output a first result;
a second comparator comparing the RX signal with a second reference voltage to output a second result;
a third comparator comparing the RX signal with a third reference voltage to output a third result; and
a logic encoder expressing the first to third results as a RXA[1:0] of 2-bit.

22. The data communication device of claim 1, wherein the first communication module converts a first transmission signal provided from an external device into a first transmission current and outputs the converted first transmission current to the data transmission line, and the second communication module outputs a first reception current, which is in the opposite phase to the first transmission current, through the data transmission line, thereby minimizing a voltage change on the data transmission line.

23. The data communication device of claim 22, wherein the second communication module mirrors the first reception current and outputs the transmission signal restored to the first received voltage.

24. The data communication device of claim 1, wherein the second communication module converts a second transmission signal provided from an external device into a second transmission current and outputs the converted second transmission current to the data transmission line, and the first communication module outputs a second reception current, which is in the opposite phase to the second transmission current, through the data transmission line, thereby minimizing a voltage change on the data transmission line.

25. The data communication device of claim 24, wherein the first communication module mirrors the second reception current and outputs the transmission signal restored to the second received voltage.

26. The data communication device of claim 1, wherein each of the first communication module and the second communication module comprises a receiving unit for receiving an RX signal in the physical layer through the data transmission line, and
wherein the receiving unit comprises a voltage generating part for converting a current of the RX signal provided through the data transmission line into a voltage.

27. The data communication device of claim 26, wherein the voltage generating part further comprises a variable resistor having a first end connected to the data transmission line and a second end connected to the current conveyor.

28. A data communication system comprising:
a data transmission line section comprising a plurality of data transmission lines arranged in parallel;
a first communication module section comprising a plurality of first communication modules arranged in parallel and is being connected to one end of the data transmission line section;
a second communication module section comprising a plurality of second communication modules arranged in parallel and is being connected to the other end of the data transmission line section;
wherein the first communication module is configured to convert a TX signal of a voltage level, provided by an external device, into a TX signal of a current level and output the converted TX signal to one side of the data transmission line, in order to communicate solely using current, free from interference between the capacitive load present on the data transmission line and the data transmission line,
the second communication module is configured to convert an RX signal of a current level, provided via the data transmission line, into an RX signal of a voltage level, in order to communicate solely using current, free from interference between the capacitive load present on the data transmission line and the data transmission line, and
the first communication module and the second communication module each include a mode switching switch that allows switching between a data transmission mode and a data receiving mode, or between a data receiving mode and a data transmission mode, controlled by a communication direction control signal, enabling bidirectional communication.
